(19) United States
(12) Patent Application Publication
(10) Pub. No.: US 2015/0241686 A1
(43) Pub. Date: Aug. 27, 2015

(54) IMAGING DEVICE, MICROSCOPE SYSTEM, AND IMAGING METHOD

(71) Applicant: OLYMPUS CORPORATION, Tokyo (JP)

(72) Inventor: Yoko ABE, Tokyo (JP)

(73) Assignee: OLYMPUS CORPORATION, Tokyo (JP)

(21) Appl. No.: 14/712,016

(22) Filed: May 14, 2015

Related U.S. Application Data
(63) Continuation of application No. PCT/JP2013/069532, filed on Jul. 18, 2013.

(30) Foreign Application Priority Data
Nov. 16, 2012 (JP) 2012-252763
May 10, 2013 (JP) 2013-100734

(51) Int. Cl. G02B 21/36; H04N 5/265

(52) U.S. Cl. CPC G02B 21/367; H04N 5/265

(57) ABSTRACT

An imaging device includes: an imaging unit configured to image an object to acquire an image of the object; an imaging controller configured to cause the imaging unit to execute imaging while moving an observation region of the imaging unit with respect to the object in at least two different directions; a degradation information acquisition unit configured to acquire degradation information that indicates degradation caused in the image acquired by the imaging unit due to the moving of the observation region; and an image processing unit configured to perform, on at least two images, image composite processing and image restoration processing based on the degradation information, the at least two images having been acquired, by the imaging unit, by moving a same observation region in different directions.

### CROSS REFERENCE TO RELATED APPLICATIONS

This application is a continuation of PCT international application Ser. No. PCT/JP2013/069532 filed on Jul. 18, 2013 which designates the United States, incorporated herein by reference, and which claims the benefit of priority from Japanese Patent Application No. 2012-252763, filed on Nov. 16, 2012 and Japanese Patent Application No. 2013-100734, filed on May 10, 2013, incorporated herein by reference.

### BACKGROUND

1. Technical Field

The disclosure relates to an imaging device, a microscope system, and an imaging method, which partially image a specimen sequentially while shifting a field of view with respect to an object, and create an image of the entire object by stitching a plurality of images obtained by the imaging.

2. Related Art

When a specimen is observed using a microscope, an observable range at a time is mainly defined according to a magnification of an objective lens. For example, as the magnification of the objective lens becomes higher, a higher resolution image can be obtained but an observation range becomes narrower. For this reason, a so-called virtual slide system is known that partially images the specimen sequentially while shifting the field of view with respect to the specimen, using an electric stage or the like, and stitches a plurality of images obtained by the imaging to create a microscope image with a wide field of view and a high resolution. The microscope image created by the virtual slide system is also called virtual slide image.

As a technology of performing imaging while moving a stage of a microscope, for example, Japanese Laid-open Patent Publication No. 2002-195811 discloses a technology of imaging an object using a camera while moving the object on an XY stage, and of performing image processing on the acquired images to measure a shape profile of the object.

### SUMMARY

In accordance with some embodiments, an imaging device, a microscope system, and an imaging method are presented.

In some embodiments, an imaging device includes: an imaging unit configured to image an object to acquire an image of the object; an imaging controller configured to cause the imaging unit to execute imaging while moving an observation region of the imaging unit with respect to the object in at least two different directions; a degradation information acquisition unit configured to acquire degradation information that indicates degradation caused in the image acquired by the imaging unit due to the moving of the observation region; and an image processing unit configured to perform, on at least two images, image composite processing and image restoration processing based on the degradation information, the at least two images having been acquired, by the imaging unit, by moving a same observation region in different directions.

In some embodiments, a microscope system includes the imaging device, and a stage on which the object is configured to be placed, and a movement unit configured to move one of the stage and the imaging unit relative to the other.

In some embodiments, an imaging method includes: an imaging step of imaging an object to acquire an image of the object while moving an observation region with respect to the object in at least two different directions; a degradation information acquisition step of acquiring degradation information that indicates degradation caused in the image acquired at the imaging step due to the moving of the observation region; and an image processing step of performing, on at least two images, image composite processing and image restoration processing based on the degradation information, the at least two images having been acquired at the imaging step by moving a same observation region in different directions.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a configuration example of a microscope system according to a first embodiment of the present invention;

FIG. 2 is a schematic diagram illustrating a configuration example of a microscope device illustrated in FIG. 1;

FIG. 3 is a diagram illustrating an example of a system parameter of a typical microscope device;

FIG. 4A is a diagram illustrating another example of the system parameter of a typical microscope device;

FIG. 4B is a diagram illustrating another example of the system parameter of a typical microscope device;

FIG. 5 is a flowchart illustrating an operation of the microscope system illustrated in FIG. 1;

FIG. 6A is a diagram for describing a scanning method in an X direction;

FIG. 6B is a diagram for describing a scanning method in a Y direction;

FIG. 7 is a flowchart illustrating details of an operation to image a specimen;

FIG. 8A is a diagram for describing a method of setting a scanning range;

FIG. 8B is a diagram for describing the method of setting a scanning range;

FIG. 8C is a diagram for describing the method of setting a scanning range;

FIG. 9 is a flowchart illustrating processing of creating a composite image in the first embodiment of the present invention;

FIG. 10 is a diagram for describing processing of compositing images acquired by scanning in two directions;

FIG. 11 is a diagram for describing the processing of compositing images acquired by scanning in two directions;

FIG. 12 is a schematic diagram illustrating degradation functions according to scanning directions of images;

FIG. 13 is a diagram for describing image restoration processing using the degradation functions;

FIG. 14 is a diagram for describing an example of processing of stitching restored composite images;

FIG. 15 is a diagram for describing an example of an imaging operation of when scanning in four directions is performed;

FIG. 16 is a diagram for describing processing of compositing images acquired by the scanning in four directions;

FIG. 17 is a diagram for describing the processing of compositing images acquired by the scanning in four directions;

FIG. 18 is a schematic diagram illustrating degradation functions according to scanning directions of images;

FIG. 19 is a diagram for describing another example of processing of stitching composite images;

FIG. 20 is a block diagram illustrating a configuration example of a microscope system according to a second embodiment of the present invention;

FIG. 21 is a flowchart illustrating an operation of the microscope system illustrated in FIG. 20;

FIG. 22 is a flowchart illustrating processing of creating a composite restored image in the second embodiment of the present invention;

FIG. 23 is a diagram for illustrating the processing of creating a composite restored image in the second embodiment of the present invention;

FIG. 24 is a diagram for describing the processing of creating a composite restored image in the second embodiment of the present invention;

FIG. 25 is a diagram for describing a specific example of processing of restoring region images using degradation functions and processing of compositing restored images;

FIG. 26 is a diagram for describing a specific example of processing of restoring region images and processing of compositing restored images in a modification 2-3;

FIG. 27 is a block diagram illustrating a configuration example of a microscope system according to a third embodiment of the present invention;

FIG. 28 is a flowchart illustrating an operation of the microscope system illustrated in FIG. 27;

FIG. 29 is a schematic diagram illustrating degradation functions serving as bases according to scanning directions of images; and

FIG. 30 is a diagram for describing processing of restoring images using the degradation functions.

### DETAILED DESCRIPTION

Exemplary embodiments of an imaging device, a microscope system, and an imaging method according to the present invention will be described below in detail with reference to the drawings. The present invention is not limited by these embodiments. The same reference signs are used to designate the same elements throughout the drawings.

In some embodiments described below, an example in which the present invention is applied to a microscope system that acquires an image of an object through an objective lens provided facing the object will be described. However, for example, the present invention can be applied to any device or system as long as the device or system can acquire an image of an object through an optical system provided facing the object, such as a digital camera.

### First Embodiment

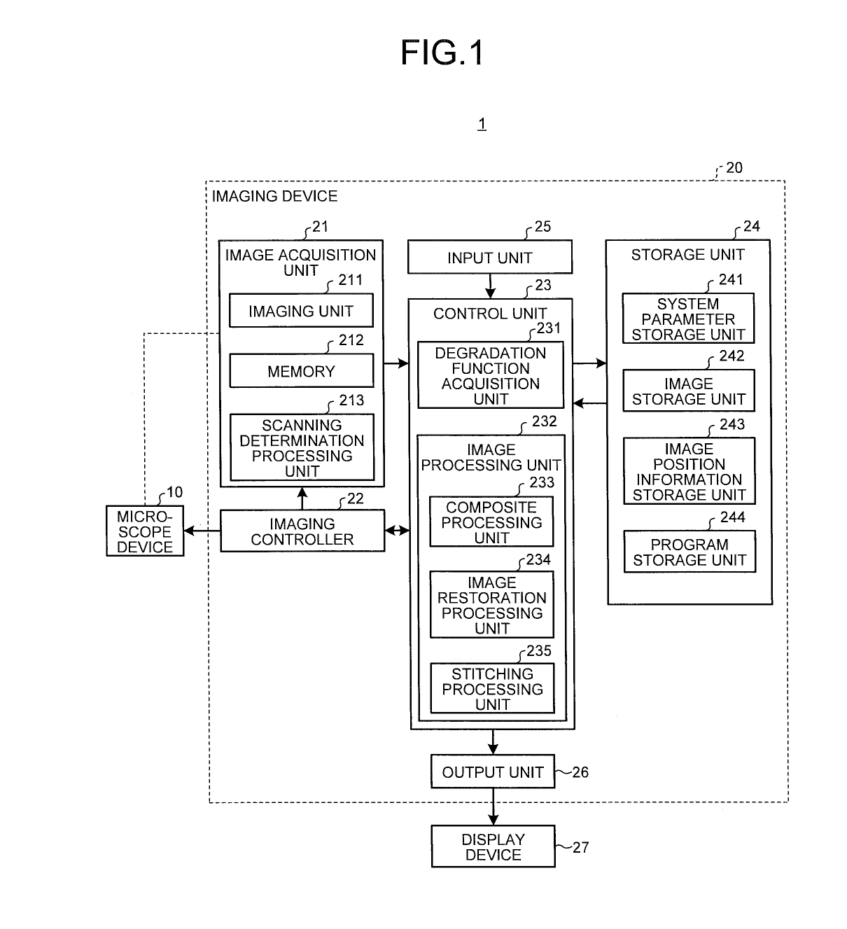

FIG. 1 is a block diagram illustrating a configuration example of a microscope system according to a first embodiment of the present invention. As illustrated in FIG. 1, a microscope system 1 according to the first embodiment includes a microscope device 10, and an imaging device 20 that images a specimen that is an object to be observed in the microscope device 10 to acquire an image. Note that, as described above, any device is applicable to the microscope device 10 as long as the device includes an imaging function (for example, a digital camera, or the like).

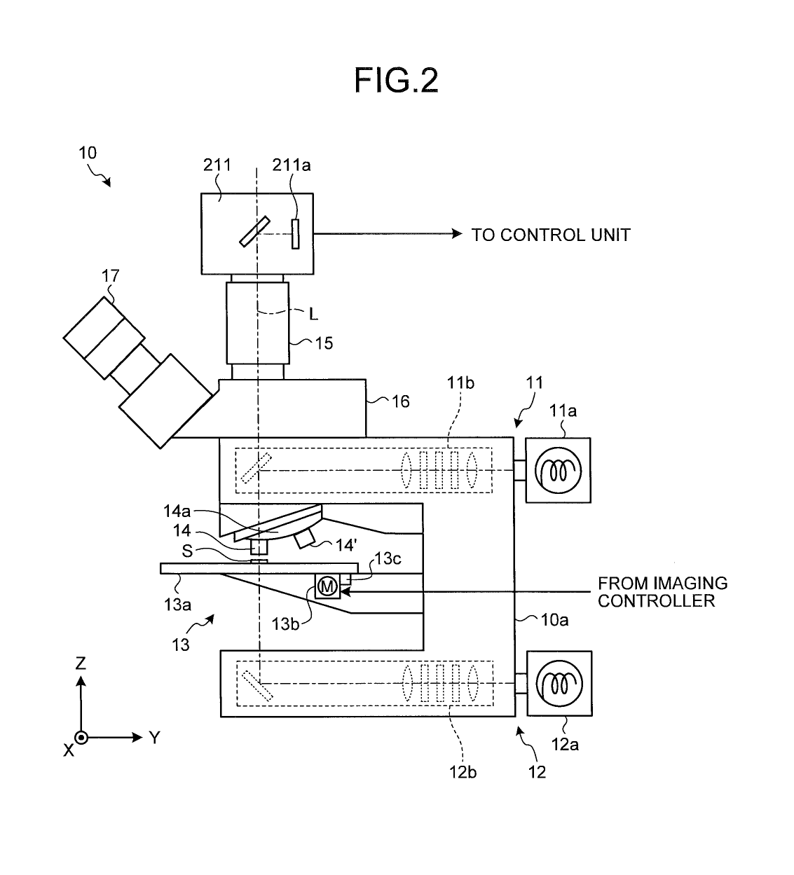

FIG. 2 is a schematic diagram illustrating a configuration example of the microscope device 10. As illustrated in FIG. 2, the microscope device 10 includes an approximately C-shaped arm 10a, an epi-illumination unit 11 and a transmission illumination unit 12, an electric stage unit 13, an objective lens 14, and an eyepiece unit 17. The epi-illumination unit 11 and the transmission illumination unit 12 are provided to the arm 10a. The electric stage unit 13 is attached to the arm 10a, and includes an electric stage 13a on which a specimen S is placed, an object being fixed to the specimen S. The objective lens 14 is provided at one end of a lens-barrel 15 through a trinocular tube unit 16 to face the electric stage 13a, and forms an image of observation light from the object.

The epi-illumination unit 11 includes an epi-illumination light source 11a and an epi-illumination optical system 11b, and irradiates the specimen S with epi-illumination light. The epi-illumination optical system 11b includes various optical members (a filter unit, a shutter, a field stop, an aperture stop, and the like) that collect illumination light emitted from the epi-illumination light source 11a and lead the collected light in a direction of an observation light path L.

The transmission illumination unit 12 includes a transmission illumination light source 12a and a transmission illumination optical system 12b, and irradiates the specimen S with transmitted illumination light. The transmission illumination optical system 12b includes various optical members (a filter unit, a shutter, a field stop, an aperture stop, and the like) that collect illumination light emitted from the transmission illumination light source 12a and lead the collected light in a direction of the observation light path L.

Either the epi-illumination unit 11 or the transmission illumination unit 12 is selected and used according to microscopy. Note that either one of the epi-illumination unit 11 and the transmission illumination unit 12 may be provided in the microscope device 10.

The electric stage unit 13 includes the electric stage 13a, a drive unit 13b that drives the electric stage 13a, and a position detector 13c. The drive unit 13b is a movement unit that includes a motor, for example, and is configured to move the electric stage 13a on a plane (that is, an XY plane) perpendicular to an optical axis of the objective lens 14 under the control of an imaging controller 22 described below. By moving of the electric stage 13a in this way, an observation region in the specimen S within a field of view of the objective lens 14 is changed. Further, the drive unit 13b causes the objective lens 14 to focus on the specimen S by moving the electric stage 13a along a Z axis.

Note that, in the first embodiment, the position of an observation optical system including the objective lens 14 and the lens-barrel 15 is fixed, and the electric stage 13a side is moved. However, the position of the stage on which the specimen S is placed may be fixed, and the observation optical system side may be moved. Alternatively, both of the electric stage 13a and the observation optical system may be moved in opposite directions. That is, any configuration may be employed as long as the configuration allows the observation optical system and the specimen S to perform relative movement. Hereinafter, an action to image the specimen S while moving the specimen S on the XY plane with respect to the objective lens 14 will be referred to as scanning.

The position detector 13c is configured from an encoder that detects an amount of rotation of the drive unit 13b made of a motor, for example, and detects the position of the electric stage 13a to output a detection signal. Note that a pulse generation unit that generates a pulse according to the control of the imaging controller 22 described below and a stepping motor may be provided in place of the drive unit 13b and the position detector 13c.

The objective lens 14 is attached to a revolver 14a that can hold a plurality of objective lenses (for example, objective lens 14′) having different magnifications. The revolver 14a is rotated, and the objective lenses 14 and 14′ facing the electric stage 13a are changed, so that an imaging magnification can be changed. In FIG. 2, the objective lens 14 faces the electric stage 13a.

The trinocular tube unit 16 branches the observation light incident from the objective lens 14 into the eyepiece unit 17 for allowing a user to directly observe the specimen S, and an imaging unit 211 described below.

Referring back to FIG. 1, the imaging device 20 includes an image acquisition unit 21, an imaging controller 22, a control unit 23, a storage unit 24, an input unit 25, and an output unit 26. The image acquisition unit 21 acquires an image by imaging the specimen S that is the object. The imaging controller 22 controls an imaging operation for causing the image acquisition unit 21 to execute imaging while moving the specimen S. The control unit 23 controls various operations in the imaging device 20, and controls specified image processing for the image acquired by the image acquisition unit 21. The storage unit 24 stores various types of image data and control programs. The input unit 25 accepts an instruction to the imaging device 20 and an input of information. The output unit 26 outputs a result of the processing by the control unit 23 and other specified information.

The image acquisition unit 21 includes the imaging unit 211, a memory 212, and a scanning determination processing unit 213. The imaging unit 211 is configured from a camera that includes an imager 211a made of a CCD or a CMOS, and can image color images having pixel levels (pixel values) in respective bands of R (red), G (green), and B (blue) in respective pixels included in the imager 211a. In the embodiment, a color image is captured. However, the embodiment is not limited to the case, and the imager may acquire a monochrome image without including a color filter. The imaging unit 211 receives the observation light of the specimen S incident on a light-receiving surface of the imager 211a through the lens-barrel 15 from the objective lens 14 (see FIG. 2), and generates image data corresponding to the observation light. Note that the imaging unit 211 may generate image data that is converted pixel values expressed in the RGB color space into pixel values expressed in a YCbCr color space.

The memory 212 is made of a recording device such as semiconductor memory like updatable and recordable flash memory, RAM, or ROM, and temporarily stores image data generated by the imaging unit 211.

The scanning determination processing unit 213 acquires information such as position information (hereinafter, referred to as image position information) of the observation region in the specimen S at each imaging timing, a moving direction of the electric stage 13a, and a camera frame number corresponding to the each imaging timing, based on a position detection result of the electric stage 13a output from the position detector 13c, and executes setting of a scanning range for the specimen S, termination determination of a scanning operation for the specimen S, determination of unnecessary frames in the image processing in the control unit 23, and the like.

The imaging controller 22 outputs a specified control signal to the microscope device 10, changes the observation range in the specimen S within the field of view of the objective lens 14 by moving the electric stage 13a in a specified direction with a specified speed, and causes the image acquisition unit 21 to image the observation range in the specimen S within the field of view of the objective lens 14.

The control unit 23 is configured from hardware such as CPU, and controls an overall operation of the imaging device 20 and the microscope system 1, based on the various types of data stored in the storage unit 24 and various types of information input from the input unit 25 by reading the programs stored in the storage unit 24, and executes the image processing of creating a virtual slide image using an image corresponding to the image data input from the image acquisition unit 21.

To be specific, the control unit 23 includes a degradation function acquisition unit 231 and an image processing unit 232. The degradation function acquisition unit 231 is a degradation information acquisition unit that acquires degradation information that indicates degradation (blur) caused in the image due to the scanning at the time of imaging, and acquires a degradation function according to the scanning direction and the scanning speed in consideration of degradation (a system parameter described below) caused by the microscope device 10 per se.

The image processing unit 232 includes a composite processing unit 233, an image restoration processing unit 234, and a stitching processing unit 235.

The composite processing unit 233 selects at least two images in which the same observation region in the specimen S appears, from an image group acquired by performing imaging while moving the electric stage 13a in at least two different directions, and creates a composite image of these two images.

The image restoration processing unit 234 restores an image (that is, creates a restored image) from which the degradation due to the scanning is decreased, by performing image restoration processing on the composite image created by the composite processing unit 233, using the degradation information acquired by the degradation function acquisition unit 231. Hereinafter, the composite image restored by the image restoration processing unit 234 will be referred to as restored composite image.

The stitching processing unit 235 creates a virtual slide image in which the entire specimen S or a necessary range in the specimen S appears, by stitching restored composite images in which mutually adjacent observation regions appear, of restored composite images restored by the image restoration processing unit 234.

The storage unit 24 is configured from a recording device such as semiconductor memory like updatable and recordable flash memory, RAM, or ROM, a recording device that includes a recording medium such as a hard disk, a MO, a CD-R, a DVD-R that is built in or connected with a data communication terminal, and a reading device that reads information recorded in the recording medium, or the like. The storage unit 24 includes a system parameter storage unit 241, an image storage unit 242, an image position information storage unit 243, and a program storage unit 244. The image storage unit 242 stores image to which the image processing has been applied by the image processing unit 232. The image position information storage unit 243 stores various types of information (position information of each observation region in the specimen S, the moving direction of the electric stage 13a, a camera frame number in each imaging timing, and the like) acquired by the scanning determination processing unit 213. The program storage unit 244 stores a control program for causing the imaging device 20 to execute a specified operation, an image processing program for causing the control unit 23 to execute specified image processing, and the like.

Here, the system parameter is a parameter such as vibration unique to the microscope system, a point image distribution function (point spread function) of the optical system, the amount of blur in a Z direction caused by heat of the illumination or the like, and is used when the degradation function acquisition unit 231 acquires the degradation function. The system parameter storage unit 241 stores the system parameter in advance.

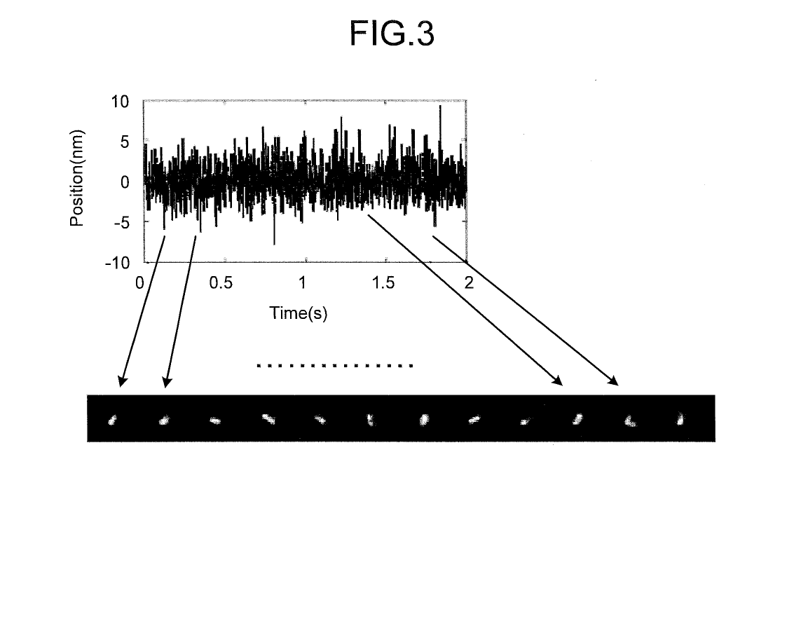

FIG. 3 is a diagram illustrating an example of the system parameter of a typical microscope device. The upper section of FIG. 3 is a graph illustrating vibration of a motor when an electric stage of the microscope device is stopped. The lower section of FIG. 3 is a schematic diagram illustrating changing point images caused by the vibration of the motor. A degradation function of image blurring caused by the vibration of the motor can be acquired by recording of such point images when the electric stage is stopped.

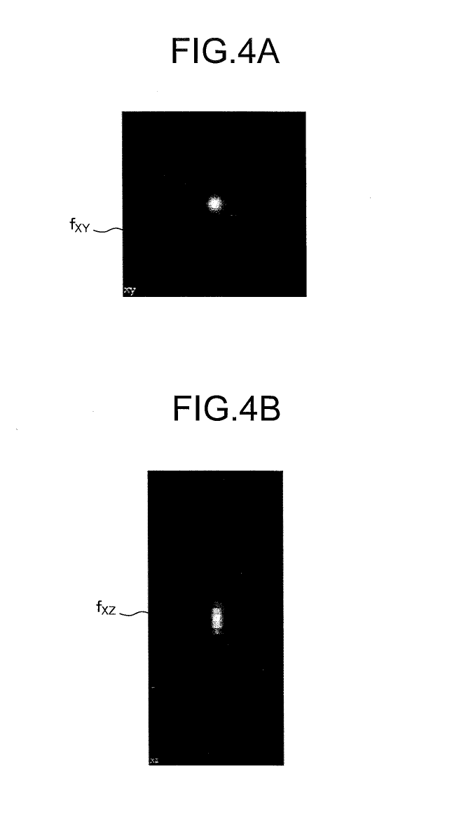

FIGS. 4A and 4B are diagrams for describing another example of the system parameter of a typical microscope device. FIG. 4A is a schematic diagram illustrating a point image in an optical system on an XY plane, and indicates the amount of blur on the XY plane caused by the optical system of the microscope device. FIG. 4B is a schematic diagram illustrating a point image in an optical system on an XZ plane, and indicates the amount of blur in a Z direction.

The input unit 25 is configured from input devices such as a keyboard, various buttons, and various switches, a pointing device such as a mouse and a touch panel, and the like, and accepts signals input through these devices and input the signals to the control unit 23.

The output unit 26 is an external interface that outputs the virtual slide image created by the control unit 23 and other specified information to an external device such as a display device 27 made of an LCD, an EL display, or a CRT display. Note that, in the first embodiment, the display device 27 is provided outside the imaging device 20. However, a display unit that displays a microscope image and the like may be provided inside the imaging device 20.

Such an imaging device 20 can be configured by combining of a general-purpose digital camera with a general device such as a personal computer or a work station, through an external interface (not illustrated).

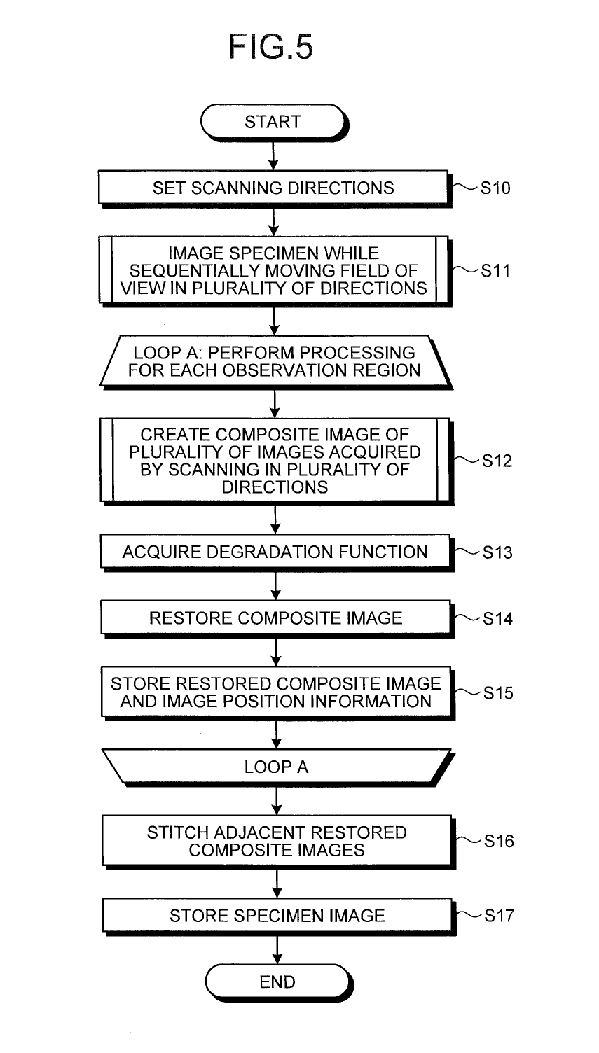

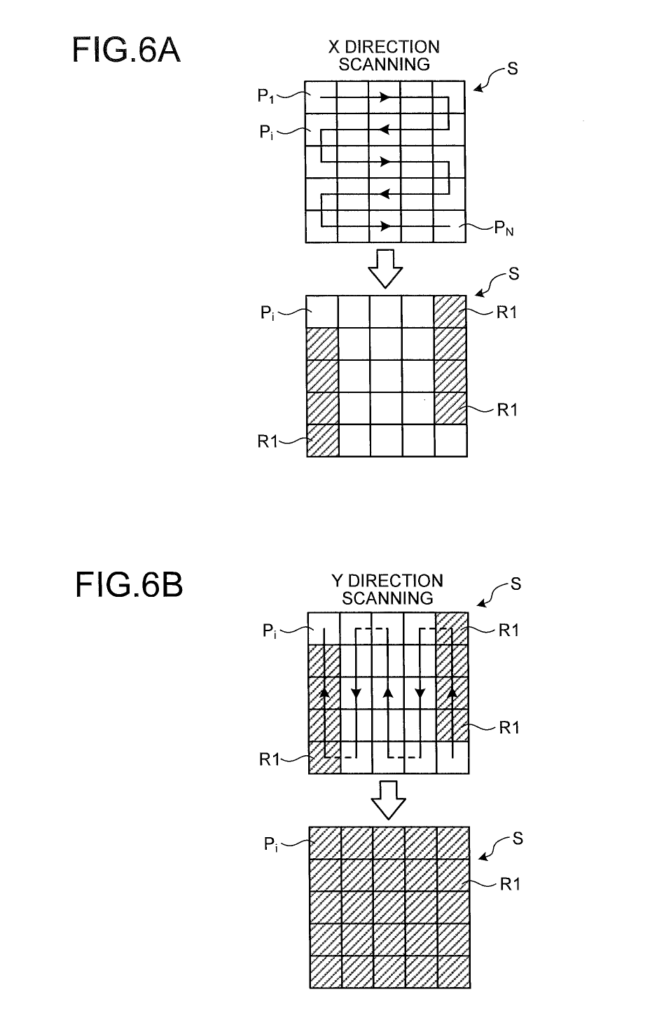

Next, an operation of the microscope system 1 will be described. FIG. 5 is a flowchart illustrating an operation of the microscope system 1. Further, FIG. 6A is a diagram for describing a scanning method in an X direction, and FIG. 6B is a diagram for describing a scanning method in a Y direction.

First, at step S10, the control unit 23 sets a plurality of directions where the specimen S is scanned. The scanning directions are not especially limited as long as the directions are different two directions or more. Favorably, an angle made by the scanning directions is made as large as possible. For example, when two scanning directions are set, it is favorable that the scanning directions are perpendicular to each other. Further, when three scanning directions are set, it is favorable that the scanning directions intersect with one another by 60 degrees. In the first embodiment, as illustrated in FIGS. 6A and 6B, scanning is performed in the two directions of the X direction and the Y direction along two sides of the specimen S.

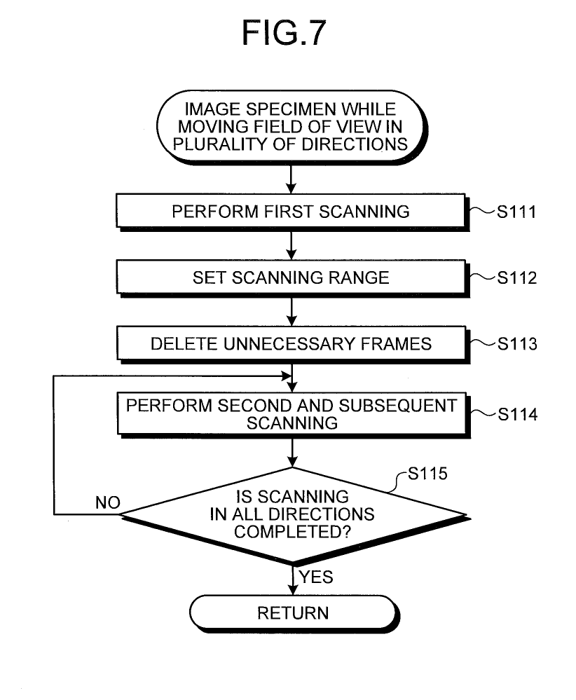

At step S11, the microscope system 1 images the specimen S while sequentially moving the field of view in the plurality of directions. FIG. 7 is a flowchart illustrating details of the operation to image the specimen S.

First, at step S111, the microscope system 1 performs first scanning in a first direction (for example, the X direction) set at step S10. To be specific, the imaging controller 22 controls the electric stage unit 13 to move the electric stage 13a in the X direction, and causes the imaging unit 211 to execute imaging at a given imaging period without stopping the electric stage 13a. Note that a moving speed of the electric stage 13a is determined according to the imaging period of the imaging unit 211 such that the observation regions in the specimen S partially overlap with each other in mutually adjacent rows or columns. A range of overlapping of the observation regions is favorably 10% of an image size corresponding to one field of view, for example. Image data generated by the imaging unit 211 is temporarily stored in the memory 212.

The scanning determination processing unit 213 sets a flag that indicates the scanning direction every time the imaging unit 211 performs imaging once (for example, changes the X direction flag from 0 to 1), stores information such as a field of view label including position information (coordinates (x,y)) of each observation region Pᵢ based on a detection signal output by the position detector 13c, and the camera frame number of when the each observation region Pᵢ is imaged (hereinafter, these pieces of information will be referred to as related information) to the memory 212, and associates the information with the image data generated by the imaging unit 211. Note that the flag that indicates each scanning direction is initially set to “0”.

For example, as illustrated in FIG. 6A, when the specimen S is scanned with the objective lens 14 in the X direction along the arrows in the drawing, observation regions Pᵢ (i is a natural number of 1 to N) in the specimen S are imaged sequentially, and the X direction flags of the imaged observation regions Pᵢ are set to “1” sequentially.

Note that, when the field of view of the objective lens 14 is shifted to a next row, the observation region Pᵢ at a turning position is also scanned in the Y direction. For such observation region Pᵢ, the scanning determination processing unit 213 sets a Y direction flag to “1” in addition to the X direction flag. Therefore, when the scanning in the X direction is completed for the entire specimen S, regions R1 where both of the scanning in the X direction and in the Y direction are completed can be obtained. Note that, in FIGS. 6A and 6B, the regions R1 are illustrated by the diagonal lines.

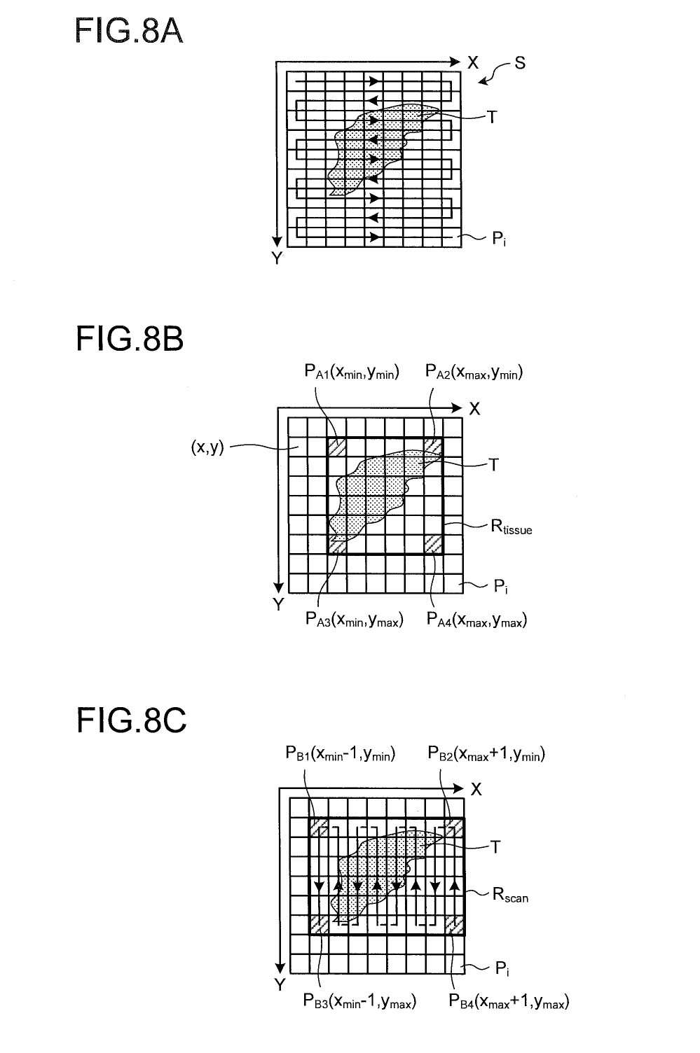

At step S112, the scanning determination processing unit 213 sets a scanning range on the specimen S. FIGS. 8A to 8C are diagrams for describing a method of setting a scanning range. Here, for example, as illustrated in FIG. 8A, when a tissue T exists only in a part of the specimen S and it is sufficient to acquire high-resolution images only for regions that include the tissue T, it is not necessary to scan the entire specimen S in all of the directions. In such a case, the scanning determination processing unit 213 sets the regions that include the tissue T to the scanning range, as described below.

First, the scanning determination processing unit 213 extracts the observation regions Pᵢ that include the tissue T by known image recognition processing, based on the image data acquired at step S111. Then, as illustrated in FIG. 8B, the scanning determination processing unit 213 sets a rectangular range surrounded by a minimum value to a maximum value of the coordinates (x, y) of the observation regions, of the observation regions Pᵢ that include the tissue T, to a tissue-existing range Rₜᵢₛₛᵤₑ. To be specific, in the observation regions Pi that include the tissue T, an X coordinate xₘₐₓ of an observation region P_{A2} becomes the maximum value of the X direction and a Y coordinate yₘᵢₙ becomes the minimum value of the Y direction, and an X coordinate xₘᵢₙ of an observation region P_{A3} becomes the minimum value of the X direction and a Y coordinate yₘₐₓ becomes the maximum value of the Y direction. Therefore, the range surrounded by observation regions P_{A1} (xₘᵢₙ, yₘᵢₙ), P_{A2} (Xₘₐₓ, Yₘᵢₙ), P_{A3} (Xₘᵢₙ, Yₘₐₓ), and P_{A4} (xₘₐₓ, Yₘₐₓ) is the tissue-existing range Rₜᵢₛₛᵤₑ.

Following that, the scanning determination processing unit 213 determines whether the observation regions P_{A1}, P_{A2}, P_{A3}, and P_{A4} at the four corners of the tissue-existing range Rₜᵢₛₛᵤₑ include the tissue T. In the case of FIG. 8B, the observation regions P_{A2} and P_{A3} include the tissue T. As described above, when some of the observation regions P_{A1}, P_{A2}, P_{A3}, and P_{A4} include the tissue T, the scanning determination processing unit 213 sets a region that is an expanded tissue-existing range Rₜᵢₛₛᵤₑ so as not to include the tissue T, as the scanning range. To be specific, as illustrated in FIG. 8C, a rectangular range surrounded by coordinates obtained by expanding of the four corners of the tissue-existing range Rₜᵢₛₛᵤₑ in the X direction by one observation region each, that is, by observation regions P_{B1} (xₘᵢₙ−1, yₘᵢₙ), P_{B2} (Xₘₐₓ+1, yₘᵢₙ), P_{B3} (xₘᵢₙ−1, yₘₐₓ), and P_{B4} (xₘₐₓ+1, yₘₐₓ) becomes a scanning range R_{scan}. Note that a region obtained by expanding of the tissue-existing range Rₜᵢₛₛᵤₑ in the Y direction may be set as the scanning range.

At step S113, the scanning determination processing unit 213 deletes the image data of the observation regions Pᵢ outside the scanning range R_{scan} and the related information thereof, of the image data acquired at step S111, as unnecessary frames. Note that regions that are in the scanning range R_{scan} but where the tissue T does not exist are not treated as the unnecessary frames because these regions are displayed as a part of the entire image of the specimen (a finally displayed virtual slide image).

Steps S112 and S113 are not essential steps. Processing of step S114 and subsequent steps may be performed using the entire specimen S as the scanning range.

At step S114, the microscope system 1 performs second and subsequent scanning in directions different from the scanning direction at step S111. For example, when the microscope system 1 has performed the scanning in the X direction at step S111 (see FIG. 6A), the microscope system 1 performs scanning in the Y direction (see FIG. 6B) at step S114.

Here, when the second and subsequent scanning is performed, scanning in the same direction may be redundantly performed for the same observation region Pᵢ. For example, as illustrated in FIG. 6B, when the field of view of the objective lens 14 is moved onto the next row in the scanning in the Y direction, the second scanning in the X direction is performed for the observation region Pᵢ at the turning position. In such a case, the scanning determination processing unit 213 deletes the image data having overlapping scanning direction obtained when the scanning in the same direction is performed for the observation region Pᵢ in which the direction flag has been already “1”, as the unnecessary frames. The arrows illustrated in FIG. 6B is a trajectory of the scanning, and the dashed parts of the arrows indicate regions from which the image data is deleted as the unnecessary frames.

At step S115, the scanning determination processing unit 213 determines whether the scanning in all of the directions set at step S10 has been completed. To be specific, the scanning determination processing unit 213 determines whether a total sum of the direction flags has reached the number of scanning directions (2 in the case of the X direction and the Y direction) set at step S10, for each observation region Pᵢ. Then, when the total sum of the direction flags has reached the number of the scanning directions, in all of the observation regions Pᵢ except the four corners, of the observation regions Pᵢ in the scanning range R_{scan}, the scanning determination processing unit 213 determines that the scanning in all of the directions has been completed.

When a direction where the scanning has not been performed remains (No at step S115), the operation of the microscope system 1 is returned to step S114. Accordingly, scanning in a direction different from step S114 is executed for the scanning range R_{scan}.

When the scanning determination processing unit 213 determines that the scanning in all of the directions has been completed (Yes at step S115), the operation of the microscope system 1 is returned to the main routine.

Note that the image acquisition unit 21 may output the acquired image data and related information to the control unit 23 when the scanning in all of the directions has been completed for all of the observation regions Pᵢ, or may output the image data and the related information to the control unit 23 as needed from the observation region Pᵢ in which all of the direction flags have become “1”. In the latter case, the control unit 23 can start processing for the image data from the observation region Pᵢ, the scanning of which in all of the directions has been completed. Therefore, a total processing time can be shortened, and thus the latter case is favorable.

Following step S11, the microscope system 1 executes processing of a loop A for each observation region Pᵢ expect the four corners in the scanning range R_{scan}.

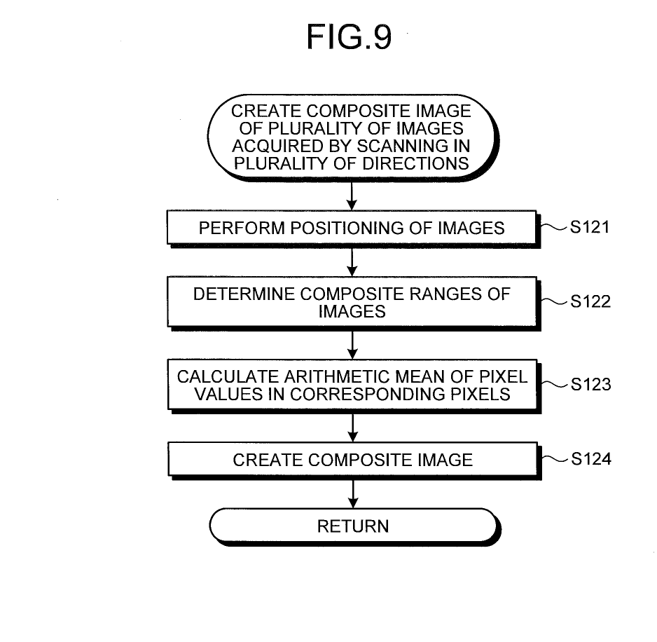

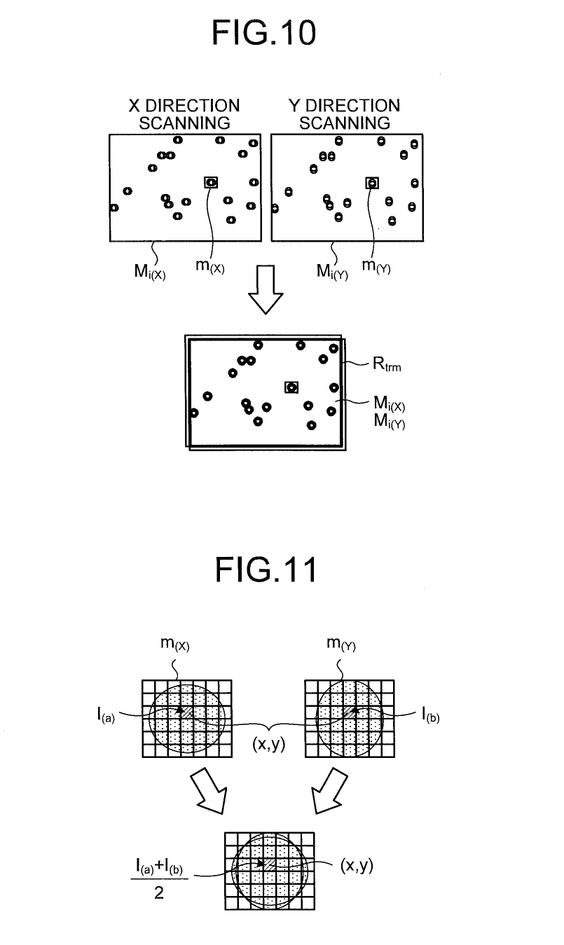

At step S12, the composite processing unit 233 creates a composite image of a plurality of images acquired by the scanning in the plurality of directions for the same observation region Pᵢ by performing specified image processing on the image data output from the image acquisition unit 21. FIG. 9 is a flowchart illustrating details of the processing of creating a composite image. Further, FIGS. 10 and 11 are diagrams for describing processing of compositing images acquired by the scanning in the two directions of the X direction and the Y direction. Hereinafter, as an example, a case of creating a composite image of an image M_{i(X)} obtained by the scanning in the X direction, and an image M_{i(Y)} obtained by the scanning in the Y direction, for the observation region Pᵢ, will be described.

At step S121, first, the composite processing unit 233 performs positioning of the images M_{i(X)} and M_{i(Y)} such that pixels, in which the same tissue appears, overlap with one another. The positioning can be executed using a known technology such as a phase-only correlation method.

At step S122, the composite processing unit 233 trims a common range Rₜᵣₘ of the images M_{i(X)} and M_{i(Y)} to determine composite ranges to composite the images M_{i(X)} and M_{i(Y)}.

At step S123, the composite processing unit 233 calculates an arithmetic mean of pixel values in mutually corresponding pixels (the pixels in which the same tissue appears) in the images M_{i(X)} and M_{i(Y)}, that is, in the pixels of the same coordinate between the images image M_{i(X)} and M_{i(Y)} after trimming. Partial images m_{(X)} and m_{(Y)} illustrated in FIG. 11 are enlarged diagrams of mutually corresponding regions (partial images m_{(X)} and m_{(Y)}) between the images M_{i(X)} and M_{i(Y)} illustrated in FIG. 10. As illustrated in FIG. 11, the composite processing unit 233 extracts pixel values I₍ₐ₎) and I_{(b)} in the pixels of the coordinates (x, y) in the respective partial images m_{(X)} and m_{(Y)}, and calculates an arithmetic means (I₍ₐ₎+I_{(b)})/2 of these pixel values.

At step S124, the composite processing unit 233 creates the composite image by using the value of the arithmetic means calculated at step S123, as the pixel value of each pixel of the composite image. In this way, the arithmetic mean of the pixel values of the images acquired by the scanning in the plurality of directions is calculated, whereby degraded image information can be corrected according to the scanning direction.

Following that, the operation of the microscope system 1 is returned to the main routine.

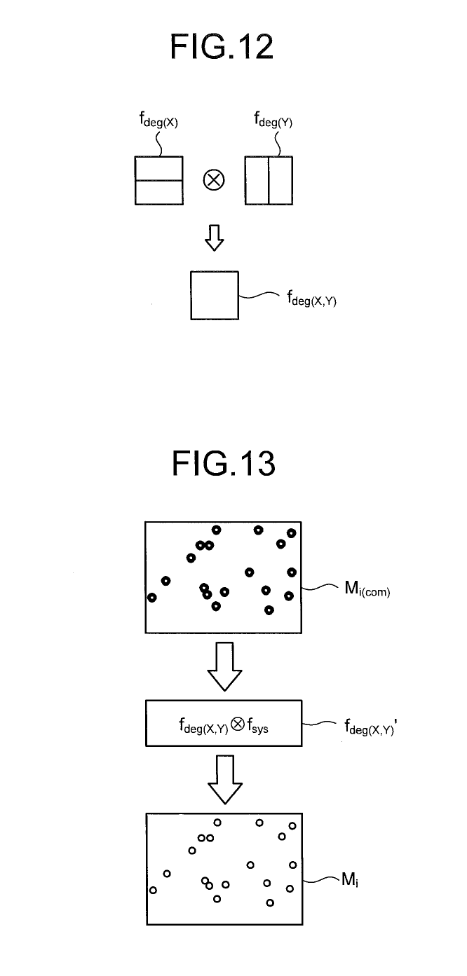

At step S13 following step S12, the degradation function acquisition unit 231 reads the related information of a plurality of images with the same observation region and different scanning directions, and acquires degradation functions, based on the scanning directions, scanning speeds, and a system parameter. To be specific, first, the degradation function acquisition unit 231 acquires degradation functions serving as bases, according to the scanning directions and the scanning speeds of the respective images. FIG. 12 is a schematic diagram illustrating degradation functions f_{deg(X)} and f_{deg(Y)} according to the scanning directions of the images M_{i(X)} and M_{i(Y)}. The degradation function acquisition unit 231 acquires an averaged degradation function f_{deg(X,Y)} by performing a convolution operation on the degradation functions f_{deg(X)} and f_{deg(Y)}. Further, the degradation function acquisition unit 231 acquires a parameter (degradation function f_{sys}) unique to the system stored in the system parameter storage unit 241. Then, the degradation function acquisition unit 231 provides degradation information unique to the system, by performing the convolution operation of the parameter unique to the system, on the averaged degradation function f_{deg(X,Y)}. Accordingly, the degradation function to be used in processing of restoring the images M_{i(X)} and M_{i(Y)} can be obtained.

At step S14, the image restoration processing unit 234 restores the composite image created at step S12 using the degradation functions acquired at step S13. FIG. 13 is a diagram for describing image restoration processing using the degradation functions. As illustrated in FIG. 13, the image restoration processing unit 234 restores a composite image M_{i(com)} of the images M_{i(X)} and M_{i(Y)} using a degradation function f_{deg(X,Y)}′ obtained by convolving of the degradation function f_{sys} to the averaged degradation function f_{deg(X,Y)}, with a weiner filter and a known algorithm such as maximum a posteriori (MAP) estimation. Accordingly, a restored composite image Mᵢ can be obtained.

At step S15, the control unit 23 stores the restored composite image Mᵢ restored at step S14 in association with the image position information included in the related information of the original images M_{i(X)} and M_{i(Y)} in the image storage unit 242, and stores the image position information in the image position information storage unit 243.

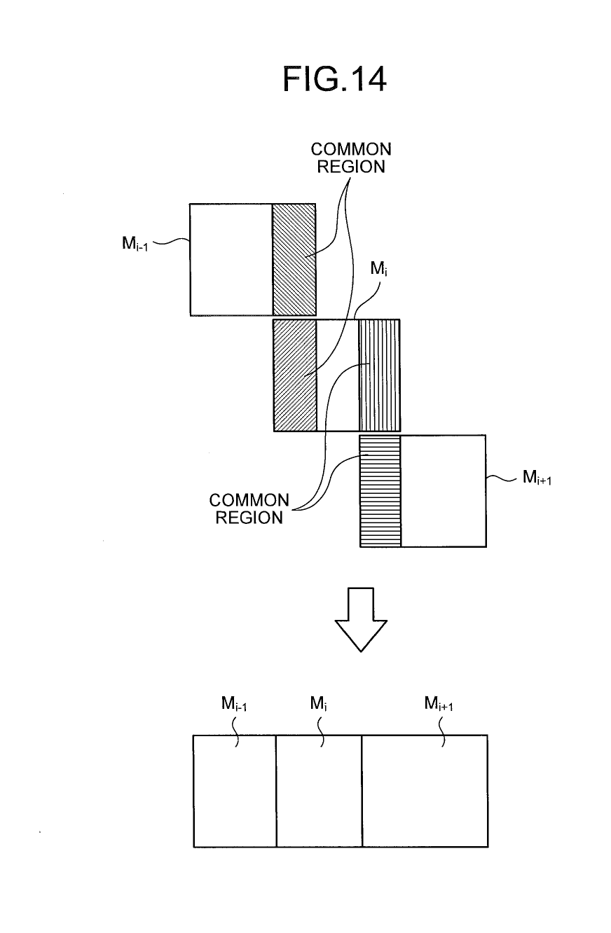

After the processing of the loop A for respective observation regions Pᵢ is completed, at step S16, the stitching processing unit 235 reads the restored composite images stored in the image storage unit 242, and stitches mutually adjacent restored composite images, by reference to the image position information associated with the respective restored composite images. FIG. 14 is a diagram for describing an example of processing of stitching the restored composite images.

As described above, adjacent observation regions Pᵢ in the specimen S (scanning range R_{scan}) are imaged to partially overlap with each other. Therefore, when stitching restored composite images Mᵢ₋₁, Mᵢ, and Mᵢ₊₁ corresponding to the observation regions Pᵢ₋₁, Pᵢ, and Pᵢ₊₁ arranged in the X direction, the stitching processing unit 235 employs one of common regions, after performing positioning to cause the common regions corresponding to overlapping ranges among the observation regions Pᵢ₋₁, Pᵢ, and Pᵢ₊₁ to overlap with each other. Either image being employed is not especially limited. Appropriate setting may just be performed such as employing an image having a larger coordinate value (for example, the restored composite image Mᵢ in the common region of the restored composite images Mᵢ₋₁ and Mᵢ, and the restored composite image Mᵢ₊₁ in the common region of the restored composite images Mᵢ and Mᵢ₊₁).

With such image composite processing, a specimen image (virtual slide image) in which the entire scanning range R_{scan} appears can be obtained. Note that the stitching processing unit 235 may start the stitching processing after completion of creation of the restored composite images for all of the observation regions Pᵢ except the four corners in the scanning range R_{scan}, or may execute the stitching processing sequentially when the restored composite images corresponding to the mutually adjacent observation regions Pᵢ₋₁ and Pᵢ, Pᵢ and Pᵢ₊₁, . . . are prepared.

At step S17, the control unit 23 stores the specimen image (virtual slide image) created as described above in the storage unit 24. Alternatively, the control unit 23 may display the specimen image in the display device 27.

As described above, according to the first embodiment, each observation region is imaged without stopping movement of the field of view for the specimen (scanning range), and thus the total imaging time can be substantially shortened, compared with the conventional technology that stops the movement every time of imaging. Further, according to the first embodiment, the same observation region is imaged by scanning in a plurality of different directions, and thus a plurality of images having different degradation directions of the images (directions where information is lacked), i.e., different directions where the images are not degraded and the information remains can be obtained. Therefore, by compositing of these images, the degradation of the images can be corrected.

Further, according to the first embodiment, the composite image is restored using the averaged degradation function obtained by averaging of the degradation functions according to the scanning directions, and thus degradation remaining in the composite image can be further decreased, and an image with high quality can be obtained. Here, the image restoration processing typically has a large load in arithmetic processing. However, in the first embodiment, the image restoration processing is performed for the composite image, and thus only one time of image restoration processing is performed for one observation region. Therefore, a total amount of arithmetic processing can be suppressed to the minimum. Therefore, by stitching of such restored composite images, a virtual slide image with high quality can be obtained at a high speed (in a short time).

### Modification 1-1

Next, a modification of the first embodiment will be described.

In the first embodiment, the scanning is performed in two directions of the X direction and the Y direction. However, the scanning directions and the number of the scanning directions are not limited thereto. For example, scanning may be performed in two directions of a direction rotated counterclockwise from an X direction by 45 decrees (hereinafter, referred to as 45-degree direction), and a direction rotated counterclockwise from the X direction by 135 degrees (hereinafter, referred to as 135-degree direction), or may be performed in four directions of the X direction, a Y direction, the 45-degree direction, and the 135-degree direction. Hereinafter, an example of the imaging operation of when scanning in the four directions is performed will be described.

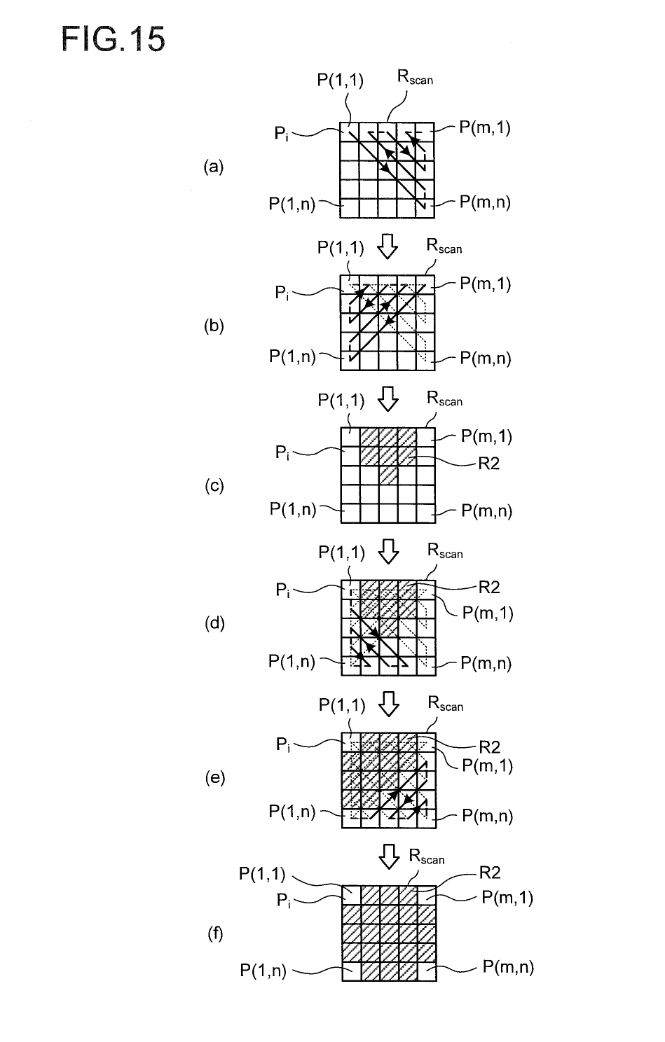

In this case, at step S11 of FIG. 5, a microscope system 1 starts scanning in the 135-degree direction from an upper left observation region P (1, 1) toward an upper right observation region P (m, 1), as illustrated in FIG. 15(a), after sequentially performing scanning in the X direction and the Y direction similarly to the first embodiment (see FIGS. 6A and 6B). Note that m is a natural number of 2 or more, and indicates the number of observation regions in the X direction. Further, the arrows illustrated in FIG. 15 are a trajectory of the scanning in the directions, and the broken line parts of the arrows indicate regions from which image data is deleted as unnecessary frames.

When the field of view of an objective lens 14 has reached the observation region P (m, 1), the microscope system 1 then starts scanning in the 45-degree direction from the observation region P (m, 1) toward the upper left observation region P (1, 1), as illustrated in FIG. 15(b). Note that the narrow dotted lines illustrated in FIG. 15(b) illustrate the trajectory of the previous scanning (the scanning in the 135-degree direction illustrated in FIG. 15(a)).

As illustrated in FIG. 15(c), at a stage where the field of view of the objective lens 14 has reached the observation region P (1, 1) again by the scanning in the 45-degree direction, a region in which the scanning in all of the directions of the X direction, the Y direction, the 45-degree direction, and the 135-degree direction has been completed (an observation region where a total number of direction flags=4) R2 can be obtained. Note that, in FIG. 15, the region R2 in which the scanning in all of the directions has been completed is illustrated by the diagonal lines.

Next, as illustrated in FIG. 15(d), the microscope system 1 starts scanning in the 135-degree direction from the observation region P (1, 1) toward a lower left observation region P (1, n). Note that n is a natural number of 2 or more, and indicates the number of observation regions in the Y direction. With the scanning, the region R2 in which the scanning in all of the directions has been completed is further increased.

When the field of view of the objective lens 14 has reached the observation region P (1, n), the microscope system 1 then starts scanning in the 45-degree direction from the observation region P (1, n) toward a lower right observation region P (m,n), as illustrated in FIG. 15(e). Then, when the field of view of the objective lens 14 has reached the observation region P (m, n), the microscope system 1 has then completed the scanning in all of the directions for all of the observation regions Pᵢ except the regions P (1, 1), P (m, 1), P (1, n), and P (m, n) at four corners of the scanning range, as illustrated in FIG. 15(f).

Note that the scanning method including the start position of the scanning in each direction, the order of the scanning, and the like is not limited to the above-described example. Any scanning method can be used as long as the method can perform scanning in all of directions set at step S10.

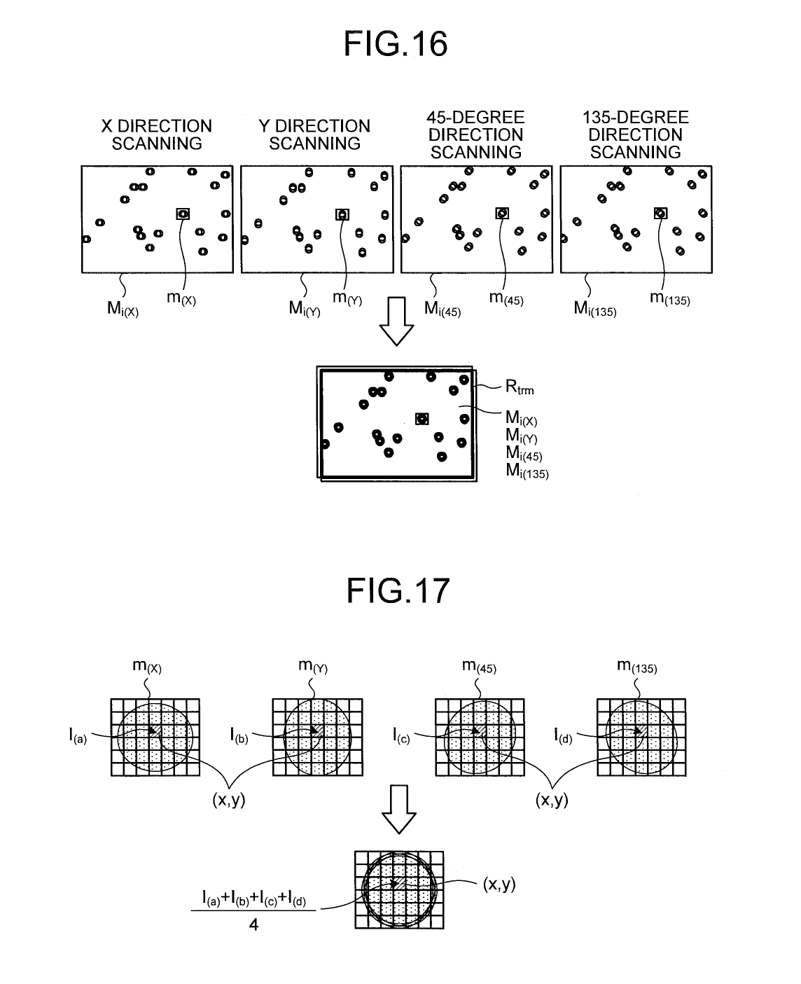

FIGS. 16 and 17 are schematic diagrams for describing processing of compositing images M_{i(X)}, M_{i(Y)}, M₁₍₄₅₎, and Mᵢ₍₁₃₅₎ acquired by the scanning in the four directions of the X direction, the Y direction, the 45-degree direction, and the 135-degree direction, for the observation regions Pᵢ. First, a composite processing unit 233 performs positioning of the images M_{i(X)}, M_{i(Y)}, Mᵢ₍₄₅₎, and Mᵢ₍₁₃₅₎ by a known technology such as a phase-only correlation method, or the like, and trims a common range Rₜᵣₘ in these images.

Partial images m_{(X)}, m_{(Y)}, m₍₄₅₎, and m₍₁₃₅₎ illustrated in FIG. 17 are enlarged diagrams of mutually corresponding partial images m_{(X)}, m_{(Y)}, m₍₄₅₎, and m₍₁₃₅₎ in the images M_{i(X)}, M_{i(Y)}, Mᵢ₍₄₅₎, and Mᵢ₍₁₃₅₎ illustrated in FIG. 16. Following that, as illustrated in FIG. 17, the composite processing unit 233 calculates an arithmetic mean (I₍ₐ₎+I_{(b)}+I_{(c)}+I_{(d)})/4 of pixel values I₍ₐ₎), I_{(b)}), I_{(c)}, and I_{(d)} in mutually corresponding pixels in the images M_{i(X)}, M_{i(Y)}, Mᵢ₍₄₅₎, and Mᵢ₍₁₃₅₎, that is, pixels of the same coordinate in the images M_{i(X)}, M_{i(Y)}, Mᵢ₍₄₅₎, and Mᵢ₍₁₃₅₎ after trimming. Then, the composite processing unit 233 employs a calculated value of the arithmetic mean, as a pixel value of each pixel of a composite image.

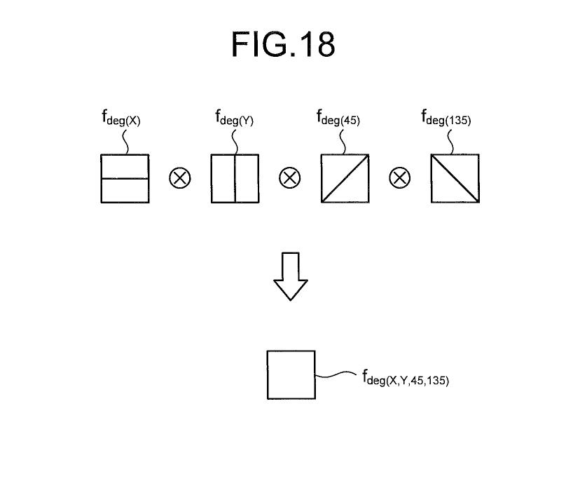

FIG. 18 is a schematic diagram illustrating degradation functions f_{deg(X)}, f_{deg(Y)}, f_{deg(45)}, and f_{deg(135)} according to the scanning directions of the images M_{i(X)}, M_{(Y)}, Mᵢ₍₄₅₎, and Mᵢ₍₁₃₅₎. The degradation function acquisition unit 231 acquires an averaged degradation function f_{deg(X, Y, 45, 135)} by performing convolution operation on the degradation functions f_{deg(X)}, f_{deg(Y)}, f_{deg(45)}, and f_{deg(135)}. In this way, when the scanning directions are increased, the degradation functions are acquired by the number corresponding to the scanning directions, and the composite image may just be restored using the degradation function f_{deg(X, Y, 45, 135)} that is obtained by averaging of the degradation functions and a system parameter (degradation function f_{sys}). Subsequent processing is similar to that in the first embodiment.

### Modification 1-2

Next, a modification 1-2 of the first embodiment will be described.

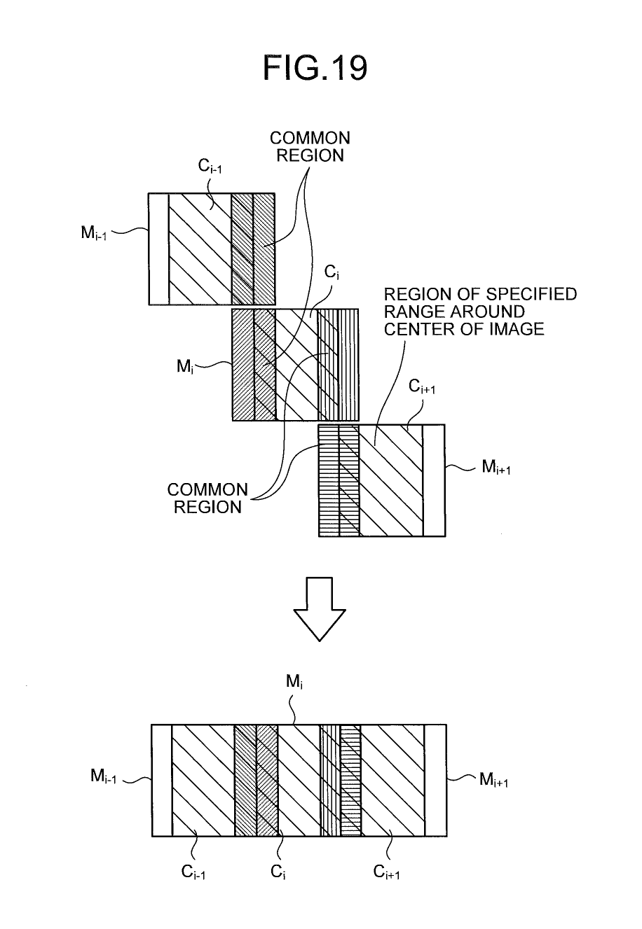

In the first embodiment, when adjacent composite images are stitched, either one of images is employed about the common region of the end parts of the composite images (see FIG. 14). However, it can be considered that, in each composite image, information around a center of the image is most stable. Therefore, the end parts of the composite images are cut off, and images including large central regions of the composite images may be stitched. To be specific, when stitching composite images Mᵢ₋₁, Mᵢ, and Mᵢ₊₁, as illustrated in FIG. 19, the stitching processing unit 235 may just cut off common regions of end parts of the composite images Mᵢ₋₁, Mᵢ, and Mᵢ₊₁, after performing positioning to cause the common regions of the composite images to overlap with each other, and may connect remaining regions Cᵢ₋₁, Cᵢ, and Cᵢ₊₁.

### Second Embodiment

Next, a second embodiment of the present invention will be described.

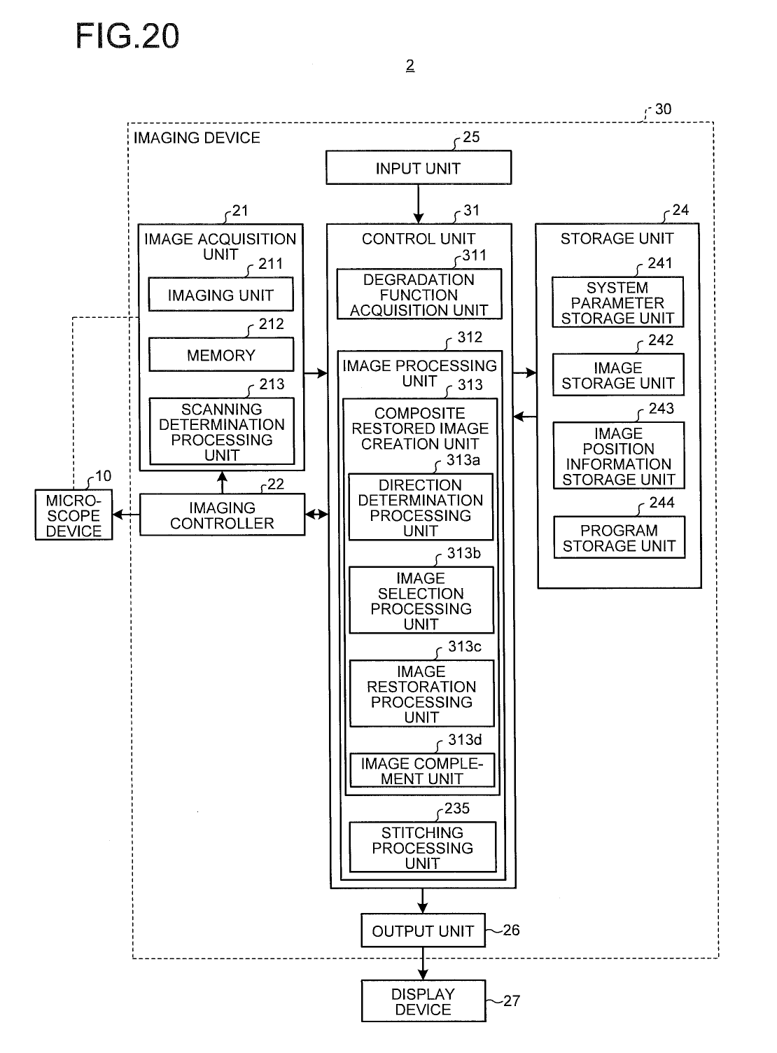

FIG. 20 is a block diagram illustrating a configuration example of a microscope system according to the second embodiment. As illustrated in FIG. 20, a microscope system 2 according to the second embodiment includes an imaging device 30 in place of the imaging device 20 illustrated in FIG. 1.

The imaging device 30 includes a control unit 31 in place of the control unit 23 illustrated in FIG. 1. Configurations and operations of units of the imaging device 30 other than the control unit 31 are similar to those in the first embodiment.

The control unit 31 includes a degradation function acquisition unit 311 and an image processing unit 312. Between them, the degradation function acquisition unit 311 is a degradation information acquisition unit that acquires degradation information that indicates degradation (blur) caused in an image due to scanning at the time of imaging, and acquires a degradation function according to a scanning direction and a scanning speed in consideration of degradation caused by a microscope device 10 per se.

The image processing unit 312 includes a composite restored image creation unit 313 and a stitching processing unit 235. Between them, an operation of the stitching processing unit 235 is similar to that in the first embodiment.

The composite restored image creation unit 313 selects a plurality of images in which the same observation region on a specimen S appears, from an image group acquired by scanning in a plurality of different directions by an image acquisition unit 21, and creates an image with decreased degradation by compositing the images. To be specific, the composite restored image creation unit 313 includes a direction determination processing unit 313a, an image selection processing unit 313b, an image restoration processing unit 313c, and an image complement unit 313d.

The direction determination processing unit 313a determines scanning directions of respective images input from the image acquisition unit 21, and calculates image selection evaluation values (hereinafter, simply referred to as evaluation values), based on the scanning directions.

The image selection processing unit 313b selects images of partial regions in respective images to be employed as images to be composited in the image complement unit 313d, based on the evaluation values, from a plurality of images with the same observation region and different scanning directions. Hereinafter, the image of a partial region (or a pixel) in the image will be referred to as region image.

The image restoration processing unit 313c creates restored images with decreased degradation due to scanning, by performing image restoration processing using degradation information acquired by a degradation function acquisition unit 331, on the region images selected by the image selection processing unit 313b.

The image complement unit 313d creates a composite image by compositing the restored region images (restored images). Hereinafter, an image obtained by compositing of the restored images will be referred to as composite restored image.

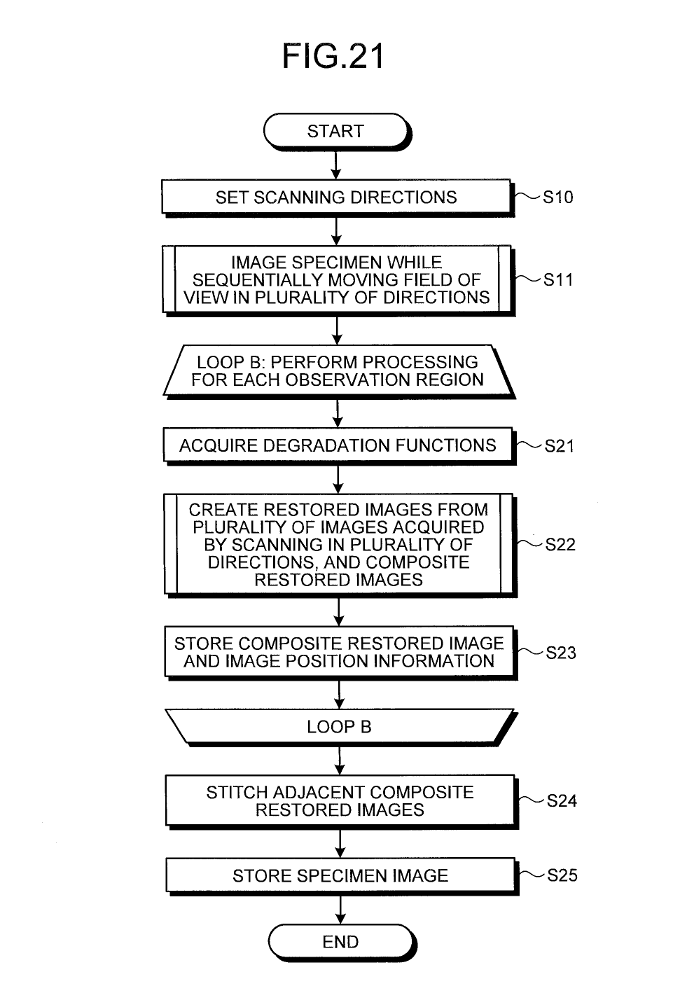

Next, an operation of the microscope system 2 will be described. FIG. 21 is a flowchart illustrating an operation of the microscope system 2. Note that steps S10 and S11 illustrated in FIG. 21 are the same as those in the first embodiment.

Following step S11, the microscope system 2 executes processing of a loop B for observation regions Pᵢ except four corners in a scanning range R_{scan}.

At step S21, the degradation function acquisition unit 331 reads related information of a plurality of images with the same observation region and different scanning directions, and acquires degradation functions, based on the scanning directions, scanning speeds, and a system parameter. For example, when scanning in four directions of an X direction, a Y direction, a 45-degree direction, and a 135-degree direction for the observation regions Pᵢ is performed, first, the degradation function acquisition unit 331 acquires degradation functions f_{deg(X)}, f_{deg(Y)}, f_{deg(45)}, and f_{deg(135)} serving as bases. The degradation function acquisition unit 331 then acquires degradation functions f_{deg(X)}′, f_{deg(Y)}′, f_{deg(45)}′, and f_{deg(135)}′ to which degradation information unique to the system is provided, by acquiring a parameter (degradation function f_{sys}) unique to the system stored in a system parameter storage unit 241 and performing a convolution operation on the degradation functions f_{deg(X)}, f_{deg(Y)}, f_{deg(45)}, and f_{deg(135)}.

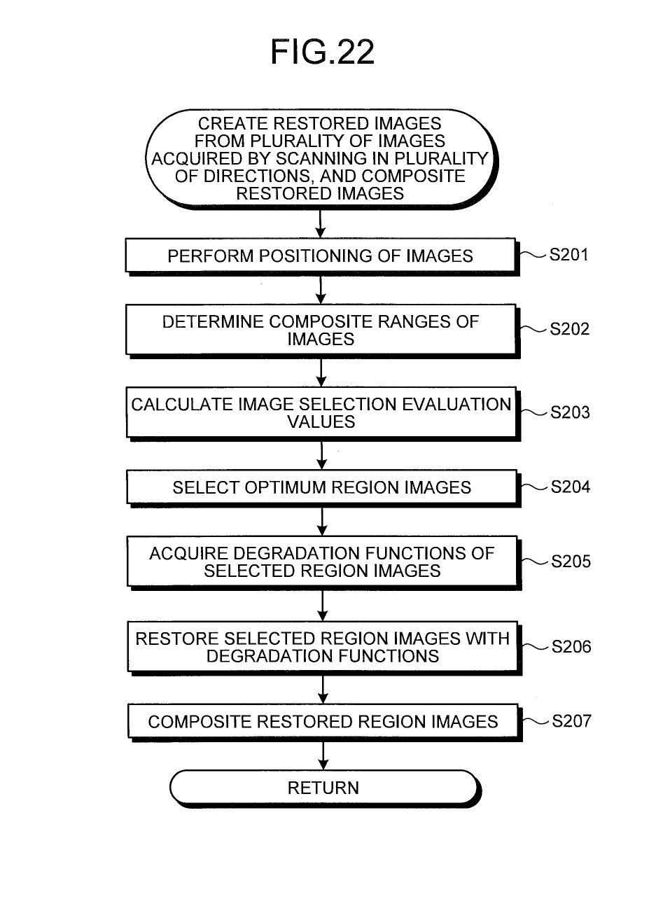

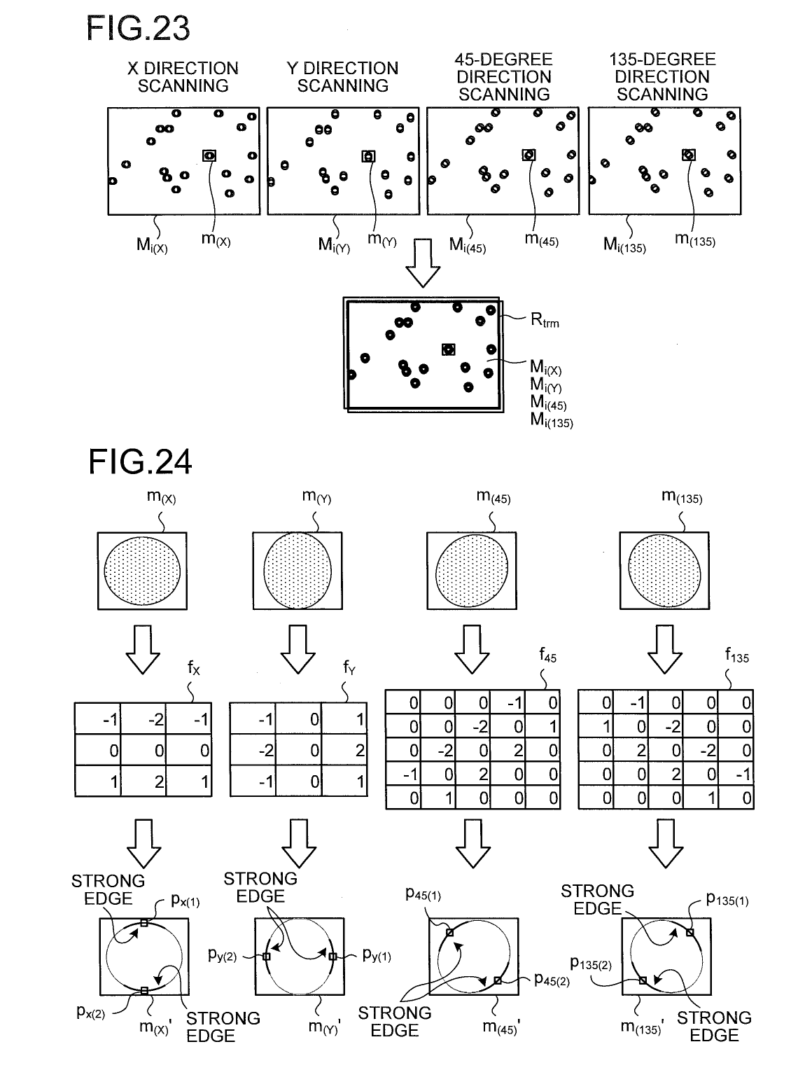

At step S22, the composite restored image creation unit 313 creates and composite the restored images from a plurality of images respectively acquired by the scanning in the plurality of directions for the same observation region Pᵢ, by performing specified image processing on the image data output from the image acquisition unit 21. FIG. 22 is a flowchart illustrating details of processing of creating a composite restored image. Further, as an example, a case of creating a composite restored image, based on images M_{i(X)}, M_{i(Y)}, Mᵢ₍₄₅₎, and Mᵢ₍₁₃₅₎ respectively acquired by scanning in the X direction, the Y direction, the 45-degree direction, and the 135-degree direction, as illustrated in FIG. 23, will be described.

At step S201, first, the composite restored image creation unit 313 performs positioning of the images image M_{i(X)}, M_{i(Y)}, Mᵢ₍₄₅₎, and Mᵢ₍₁₃₅₎. The positioning can be executed using a known technology such as a phase-only correlation technology.

At step S202, the composite restored image creation unit 313 trims a common range Rₜᵣₘ of the images M_{i(X)}, M_{i(Y)}, Mᵢ₍₄₅₎, and Mᵢ₍₁₃₅₎ to determine composite ranges to composite the images M_{i(X)}, M_{i(Y)}, Mᵢ₍₄₅₎, and Mᵢ₍₁₃₅₎.

At step S203, the direction determination processing unit 313a calculates image selection evaluation values, based on the scanning directions of the respective images M_{i(X)}, M_{i(Y)}, Mᵢ₍₄₅₎, and Mᵢ₍₁₃₅₎. Here, the image selection evaluation value is an evaluation value used when the region images to be employed are selected from respective images in creating a composite image.

A method of calculating the image selection evaluation values will be described with reference to FIG. 24. Partial images m_{i(X)}, m_{i(Y)}, mᵢ₍₄₅₎, and mᵢ₍₁₃₅₎ illustrated in FIG. 24 are enlarged diagrams of mutually corresponding partial images m_{i(X)}, m_{i(Y)}, mᵢ₍₄₅₎, and mᵢ₍₁₃₅₎ in the images M_{i(X)}, M_{i(Y)}, Mᵢ₍₄₅₎, and Mᵢ₍₁₃₅₎ illustrated in FIG. 23.

First, the direction determination processing unit 313a acquires the scanning directions from the related information of the respective mages M_{i(X)}, M_{i(Y)}, Mᵢ₍₄₅₎, and Mᵢ₍₁₃₅₎, and extracts edges from the respective images M_{i(X)}, M_{i(Y)}, Mᵢ₍₄₅₎, and Mᵢ₍₁₃₅₎ using edge extraction filters f_{X}, f_{Y}, f₄₅, and f₁₃₅ according to the scanning directions. The edge extraction filters f_{X}, f_{Y}, f₄₅, and f₁₃₅ according to the scanning directions are set to extract edges parallel to the scanning directions. With the processing, edge images m_{i(X)}′, m_{i(Y)}′, mᵢ₍₄₅₎′, and mᵢ₍₁₃₅₎′ extracted from the respective partial images m_{i(X)}, m_{i(Y)}, mᵢ₍₄₅₎, and mᵢ₍₁₃₅₎ are calculated.

Here, even if the specimen S is imaged while the scanning is performed, not much blur is caused in the direction parallel to the scanning direction, and thus as illustrated in the respective edge images m_{i(X)}′, m_{i(Y)}′, mᵢ₍₄₅₎′, and mᵢ₍₁₃₅₎′, the edges parallel to the scanning directions are stored. Therefore, a strong edge is extracted from the image M_{i(X)} mainly in the X direction, a strong edge is extracted from the image M_{i(Y)} mainly in the Y direction, a strong edge is extracted from the image Mᵢ₍₄₅₎ mainly in the 45-degree direction, and a strong edge is extracted from the image Mᵢ₍₁₃₅₎ mainly in the 135-degree direction.

Pixel values (that is, edge strengths) of respective pixels of the edge images m_{i(X)}′, m_{i(Y)}′, mᵢ₍₄₅₎′, and mᵢ₍₁₃₅₎′ calculated in this way are used as the image selection evaluation values.

Note that the specific forms of the edge extraction filters f_{X}, f_{Y}, f₄₅, and f₁₃₅ are not limited to the example illustrated in FIG. 24. Further, FIG. 24 exemplarily illustrates 3×3 matrix filters, as the edge extraction filters f_{X} and f_{Y}, and exemplarily illustrates 5×5 matrix filters, as the edge extraction filters f₄₅ and f₁₃₅. However, the sizes of the filters are not limited to the examples. As an example, the 3×3 matrix filters are used as the edge extraction filters f₄₅ and f₁₃₅, and the processing may be accelerated.

Further, a method of extracting the edges is not limited to the above-described method as long as the method can extract edges parallel to the scanning directions.

At step S204, the image selection processing unit 313b selects optimum region images to be used for image composite, from the images M_{i(X)}, M_{i(Y)}, Mᵢ₍₄₅₎, and Mᵢ₍₁₃₅₎, based on the image selection evaluation values. To be specific, the image selection processing unit 313b compares the four image selection evaluation values according to the respective scanning directions, for each partial region or pixel in an image, and selects a scanning direction with the largest image selection evaluation value (that is, a direction with the strongest edge). The image selection processing unit 313b then selects the image of the selected scanning direction, as the optimum region image in the partial region or pixel. For example, pixels pₓ₍₁₎, pₓ₍₂₎, p_{y(1)}, p_{y(2)}, p₄₅₍₁₎, p₄₅₍₂₎, p₁₃₅₍₁₎, and p₁₃₅₍₂₎ illustrated in the respective edge images m_{i(X)}′, m_{i(Y)}′, mᵢ₍₄₅₎′, and mᵢ₍₁₃₅₎′ of FIG. 24 indicate pixels with the largest image selection evaluation values, of mutually corresponding pixels in the M_{i(X)}, M_{i(Y)}, Mᵢ₍₄₅₎, and Mᵢ₍₁₃₅₎.

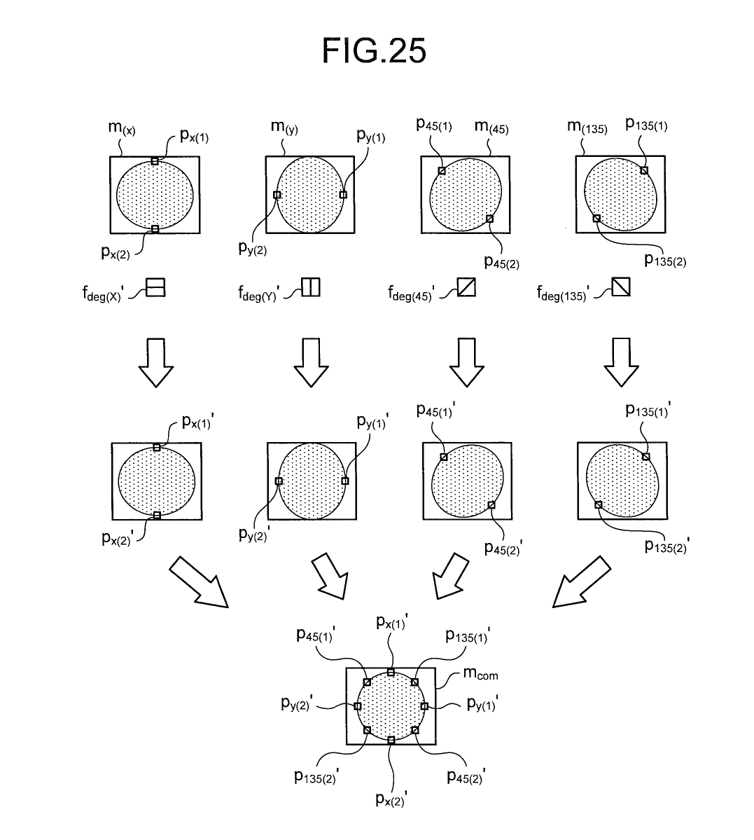

At step S205, the image restoration processing unit 313c acquires degradation functions of the region images selected at step S204. To be specific, the image restoration processing unit 313c acquires a degradation function according to an edge direction of the selected region image, from among degradation functions f_{deg(X)}′, f_{deg(Y)}′, f_{deg(45)}′ and f_{deg(135)}′ acquired in step S21. For example, as illustrated in FIGS. 24 and 25, the degradation function f_{deg(X)}° is selected for the region images (pixels pₓ₍₁₎ and pₓ₍₂₎) having the edges in the X direction. Similarly, the degradation functions f_{deg(Y)}′, f_{deg(45)}′, and f_{deg(135)}′ are selected for the region images (pixels p_{y(1)} and p_{y(2)} having the edges in the Y direction, the region images (pixels p₄₅₍₁₎ and p₄₅₍₂₎) having the edges in the 45-degree direction, and the region images (pixels P₁₃₅₍₁₎ and p₁₃₅₍₂₎) having the edges in the 135-degree direction, respectively.

At step S206, the image restoration processing unit 313c creates a restored image of each region by restoring the region image selected at step S204 with the degradation function acquired at step S204.

For example, in the case of FIG. 25, the image restoration processing unit 313c creates restored images pₓ₍₁₎′ and pₓ₍₂₎)′ by performing image restoration processing on the pixels pₓ₍₁₎ and pₓ₍₂₎ that are the region images in the partial image m_{(X)} using the degradation function f_{deg(X)}′. Similarly, the image restoration processing unit 313c creates restored images p_{y(1)}′ and p_{y(2)}′ from the pixels p_{y(1)} and p_{y(2)} in the partial image m_{(Y)}, restored images p₄₅₍₁₎′ and p₄₅₍₂₎′ from the pixels p₄₅₍₁₎ and p₄₅₍₂₎ in the partial image m₍₄₅₎, and restored images P₁₃₅₍₁₎′ and P₁₃₅₍₂₎′ from the pixels p₁₃₅₍₁₎ and P₁₃₅₍₂₎ in the partial image m₍₁₃₅₎. The image restoration processing is applied only to one selected region image, among a plurality of region images corresponding to one region or pixel. Note that, a technique of the image restoration processing is as described in the first embodiment (see step S14 of FIG. 5).

At step S207, the image complement unit 313d creates a composite restored image by compositing the region images (restored images of the respective regions) restored by the image restoration processing unit 313c. To be specific, as illustrated in FIG. 25, the image complement unit 313d employs pixel values of the restored images pₓ₍₁₎′, pₓ₍₂₎′, p_{y(1)}′, p_{y(2)}′, p₄₅₍₁₎′, p₄₅₍₂₎′, p₁₃₅₍₁₎′, and p₁₃₅₍₂₎′, as the pixel values of the regions or pixels in a composite image m_{com}.

At step S23 following step S22, the control unit 31 stores the composite restored image created at step S22 in an image storage unit 242 in association with image position information included in the related information of the original images M_{i(X)}, M_{i(Y)}, M₁₍₄₅₎, and Mᵢ₍₁₃₅₎, and stores the image position information in an image position information storage unit 243.

After the processing of the loop B for the observation regions Pᵢ has been completed, at step S24, the stitching processing unit 235 reads the composite restored images stored in the image storage unit 242, and stitches mutually adjacent composite restored images, by reference to the image position information associated with the respective composite restored images. Note that details of processing of stitching the composite restored images are similar to the processing of stitching the restored composite images described in the first embodiment (see FIGS. 14 and 19).

At step S25, the control unit 31 stores a specimen image (virtual slide image) created in this way in a storage unit 24. Alternatively, the control unit 31 may display the specimen image on a display device 27.

As described above, in the second embodiment, the plurality of images with different degradation directions of images (directions where the images are not degraded and information remains) is acquired by the scanning in the plurality of directions, and the region images to be used for image composite are selected based on the image selection evaluation values from these images. Then, the image restoration processing using the degradation functions is applied only to the selected region images, and the restored images are created. The composite restored image is created by compositing of these restored images. Therefore, lack of information caused in an image in a certain scanning direction can be complemented from an image in another scanning direction, and thus the degradation can be highly accurately corrected.

Further, in the second embodiment, only the region image with the strongest edge, of the plurality of region images corresponding to one region or pixel, is restored using the degradation function according to the direction of the edge, and the restored region images (restored images) are composited. Here, a load of arithmetic processing in the image restoration processing is typically large. However, in the second embodiment, the image restoration processing is performed only once for one region. Therefore, a total arithmetic amount required in the image restoration processing can be suppressed to the minimum. Further, the image restoration processing is performed using the optimum degradation function for the region image, rather than by averaging different degradation functions, and thus image restoration accuracy can be improved. Therefore, the composite restored images created in this way are stitched, whereby a virtual slide image with higher quality can be acquired at a high speed (in a short time).

### Modification 2-1

Next, a modification of the second embodiment will be described.

In calculating image selection evaluation values, edges may be extracted from an image obtained with an arithmetic mean of images M_{i(X)}, M_{i(Y)}, Mᵢ₍₄₅₎, and Mᵢ₍₁₃₅₎, similarly to the first embodiment or the modification 1-1. In this case, four filter processes that extract edges in an X direction, a Y direction, and a 45-degree direction, and a 135-degree direction, respectively, are applied to the image obtained with the arithmetic mean, so that four edge images are calculated, and pixel values (edge strengths) of these edge images are used as the image selection evaluation values according to scanning directions.

### Modification 2-2

In the second embodiment, the edge strengths are used as the image selection evaluation values. However, not only the edge strengths, but also the degrees of degradation as long as the degrees of degradation of an image can be evaluated for respective scanning directions. For example, contrast change in adjacent micro regions or adjacent pixels in an image may be used as the image selection evaluation values.

### Modification 2-3

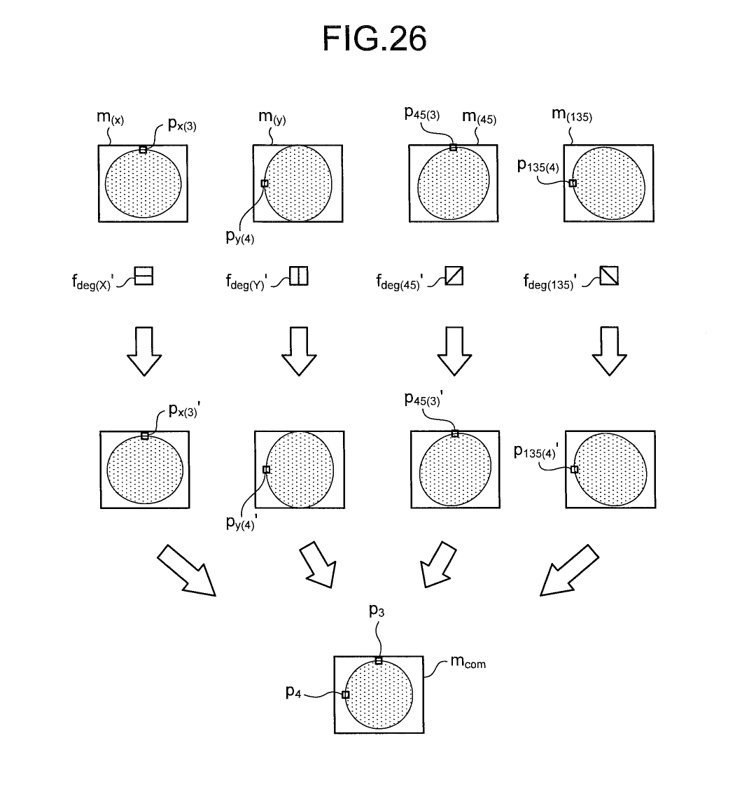

In the second embodiment, the image restoration processing is applied only to one region image, of a plurality of regions images corresponding to one region or pixel. However, a plurality of region images may be extracted based on image selection evaluation values, and image restoration processing may be applied to the plurality of extracted region images. FIG. 26 is a diagram for describing a specific example of processing of restoring region images and processing of compositing restored images in the modification 2-3.

In the modification 2-3, at step S204 illustrated in FIG. 22, one or more region images are selected based on image selection evaluation values calculated at step S203. To be specific, an image selection processing unit 313b compares a plurality of (for example, four) image selection evaluation values according to scanning directions, and selects a scanning direction with the largest image selection evaluation value and a scanning direction with the second largest image selection evaluation value.

The image selection processing unit 313b compares the largest image selection evaluation value (hereinafter, maximum evaluation value), and the second largest image selection evaluation value (hereinafter, second evaluation value), and when the second evaluation value is substantially smaller than the maximum evaluation value, the image selection processing unit 313b selects only a region image having the maximum evaluation value. When a difference between the maximum evaluation value and the second evaluation value is small, the image selection processing unit 313b selects the region image having the maximum evaluation value, and a region having the second evaluation value.

It is favorable to perform determination of this time by setting a threshold based on the difference between the maximum evaluation value and another image selection evaluation value. To be specific, it is favorable to set the threshold as follows. First, image selection evaluation values E₁, E₂, . . . of a plurality of corresponding region images are acquired. Then, differences ΔE₁ (=Eₘₐₓ−E₁), ΔE₂ (=Eₘₐₓ−E₂), . . . between a maximum image selection evaluation value Eₘₐₓ, of the image selection evaluation values, and other image selection evaluation values E₁, E₂, . . . . Then, an average μ and a standard deviation σ of these differences ΔE₁, ΔE₂, . . . are calculated, and a sum μ+σ of the average and the standard deviation are employed as the threshold.

In selecting the region images, only the region image having the maximum evaluation value may just be selected when the difference between the maximum evaluation value and the second evaluation value is larger than the threshold μ+σ, and the region image having the maximum evaluation value and the region having the second evaluation value may just be selected when the difference between the maximum evaluation value and the second evaluation value is the threshold μ+σ or less. Note that, when three or more image selection evaluation values exist, which have the difference the image selection evaluation values and the maximum evaluation value being the threshold μ+σ, all of the region images having the image selection evaluation values may be selected.

In FIG. 26, a pixel pₓ₍₃₎ in a partial image m_{(X)} obtained by scanning in an x direction, and a pixel p₄₅₍₃₎ corresponding to the pixel pₓ₍₃₎, in a partial image m₍₄₅₎ obtained by scanning in a 45-degree direction, are selected, and a pixel p_{y(4)} in a partial image m_{(Y)} obtained by scanning in a y direction and a pixel P₁₃₅₍₄₎ corresponding to the pixel p_{y(4)}, in a partial image m₍₁₃₅₎ obtained by scanning in a 135-degree direction, are selected.

When two or more region images has been selected from a plurality of region images corresponding to one region or pixel at step S204, at step S205, a degradation function acquisition unit 311 acquires degradation functions according to edge directions, for the selected respective region images. In the case of FIG. 26, degradation functions f_{deg(X)}′, f_{deg(Y)}′, f_{deg(45)}′, f_{deg(135)}′, are selected for the pixels pₓ₍₃₎, p_{y(4)}, p₄₅₍₃₎, and p₁₃₅₍₄₎.

Further, in this case, at step S206, an image restoration processing unit 313c performs image restoration processing on the selected respective region images, using the degradation functions. In the case of FIG. 26, the image restoration processing unit 313c acquires restored images pₓ₍₃₎′ and p₄₅₍₃₎′ by restoring the pixels pₓ₍₃₎ and p₄₅₍₃₎ that are corresponding region images, using the degradation functions f_{deg(X)}′ and f_{deg(45)}′. Further, the image restoration processing unit 313c acquires restored images p_{y(4)}′ and P₁₃₅₍₄₎′ by restoring the pixels p_{y(4)} and p₁₃₅₍₄₎ that are corresponding region images, using the degradation functions f_{deg(Y)}′ and f_{deg(135)}′. That is, here, the image restoration processing has been performed twice for one region or pixel.

In this case, composite processing at step S207 is performed as follows. An image complement unit 313d acquires pixel values of a plurality of corresponding restored pixels, and employs an averaged value of the pixel values of the restored pixels, as a pixel value of the region or pixel. In the case of FIG. 26, the pixel value of a pixel p₃ in a composite restored image is provided by (Iₚₓ₍₃₎+Iₚ₄₅₍₃₎)/2 where the pixel values of the restored images pₓ₍₃₎, p_{y(4)}, p₄₅₍₃₎, and p₁₃₅₍₄₎ are Iₚₓ₍₃₎, I_{py(4)}, Iₚ₄₅₍₃₎, and Iₚ₁₃₅₍₄₎, respectively. Further, the pixel value of a pixel p₄ in the composite restored image is provided by (I_{py(4)}+Iₚ₁₃₅₍₄₎)/2.

As described above, in the modification 2-3, the image restoration processing is performed for two or more region images, of the plurality of region images corresponding to one region or pixel. Here, a structure of an object does not necessarily completely accord with the scanning directions, and thus information in a direction different from the scanning directions does not always remain without being degraded. In such a case, information of a plurality of directions that can be considered to have remaining information in a substantially manner is used based on the image selection evaluation values, whereby information that may be lacked in the case of only one direction can be highly accurately complemented. Therefore, by stitching of the composite restored images created in this way, a virtual slide image with higher quality can be obtained.

### Third Embodiment

Next, a third embodiment of the present invention will be described.

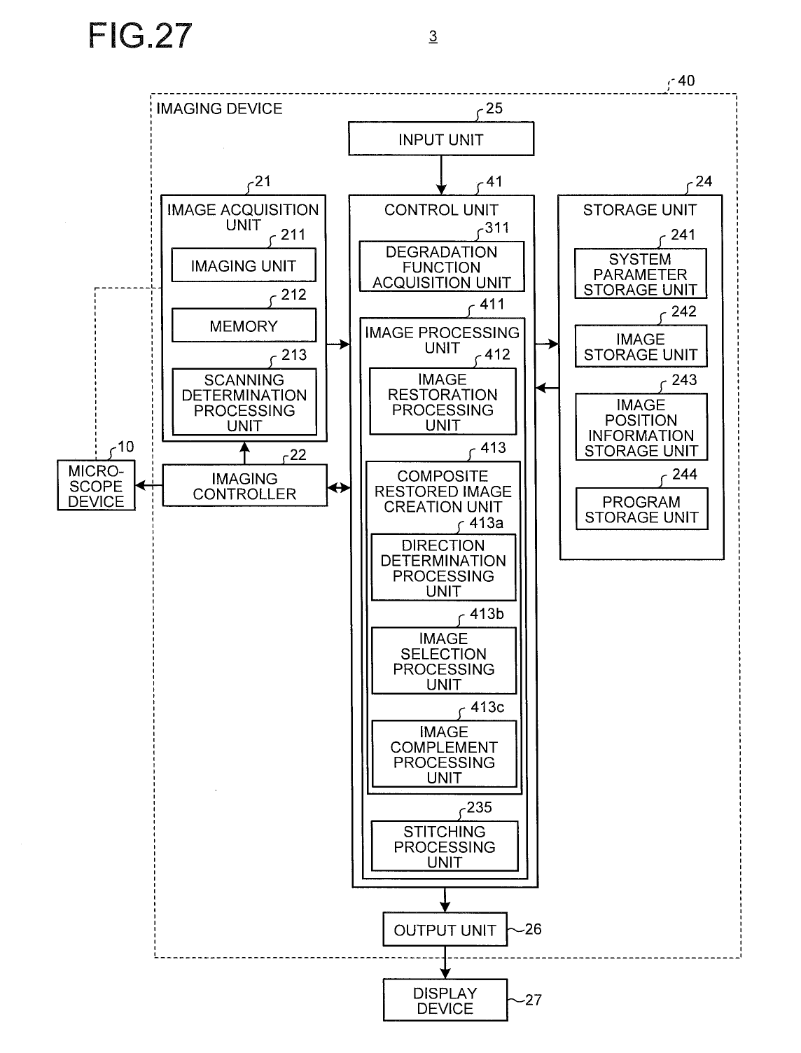

FIG. 27 is a block diagram illustrating a configuration example of a microscope system according to the third embodiment. As illustrated in FIG. 27, microscope system 3 according to the third embodiment includes an imaging device 40 in place of the imaging device 30 illustrated in FIG. 20.

The imaging device 40 includes a control unit 41 in place of the control unit 23 illustrated in FIG. 1. Configurations and operations of units of the imaging device 40 other than the control unit 41 are similar to those in the second embodiment.

The control unit 41 includes a degradation function acquisition unit 311, an image processing unit 411, and a stitching processing unit 235. Among them, an operation of the degradation function acquisition unit 311 is similar to that in the second embodiment. Further, an operation of the stitching processing unit 235 is similar to that in the first embodiment.

The image processing unit 411 includes an image restoration processing unit 412 and a composite restored image creation unit 413. The image restoration processing unit 412 creates restored images by performing image restoration processing on respective images acquired by scanning in a plurality of different directions by an image acquisition unit 21, using degradation functions according to the scanning directions of the images.

The composite restored image creation unit 413 creates a composite restored image by compositing the plurality of restored images created by the image restoration processing unit 412. To be specific, the composite restored image creation unit 413 includes a direction determination processing unit 413a, an image selection processing unit 413b, and an image complement unit 413c.

The direction determination processing unit 413a determines the scanning directions of the respective restored images created by the image restoration processing unit 412, and calculates image selection evaluation values based on the scanning directions.

The image selection processing unit 413b selects regions in the respective restored images to be employed as images to be composited in the image complement unit 413c described below, from the plurality of restored images with the same observation region and different scanning directions, based on the evaluation values.

The image complement unit 413c creates the composite restored image by compositing the regions selected by the image selection processing unit 413b.

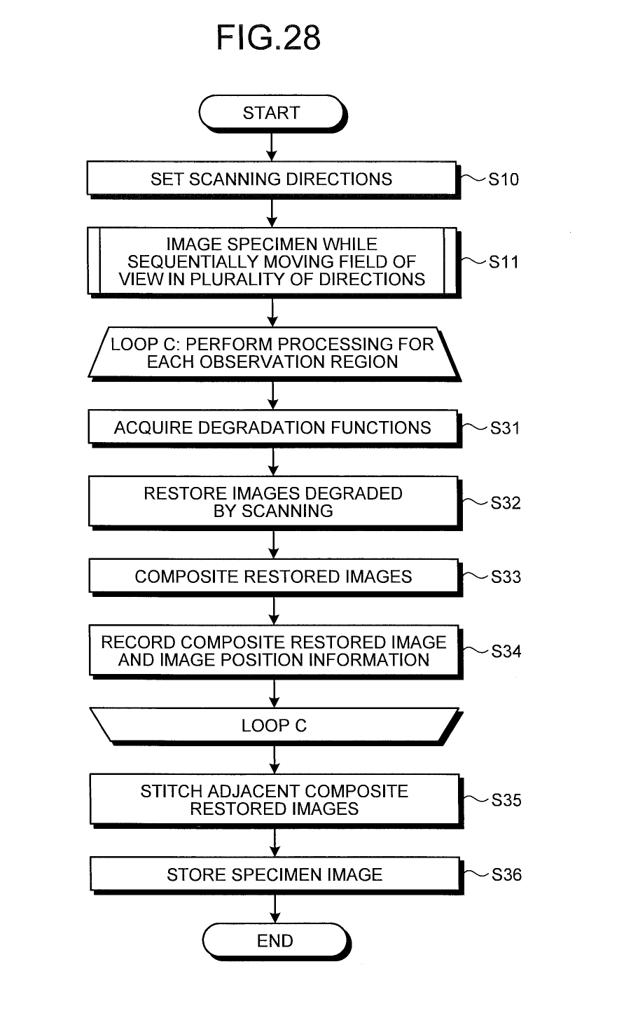

Next, an operation of the microscope system 3 will be described. FIG. 28 is a flowchart illustrating an operation of the microscope system 3. Note that steps S10 and S11 of FIG. 28 are the same as those in the first embodiment (see FIG. 5).

Following step S11, the control unit 41 executes processing of a loop C for respective observation regions acquired at step S11.

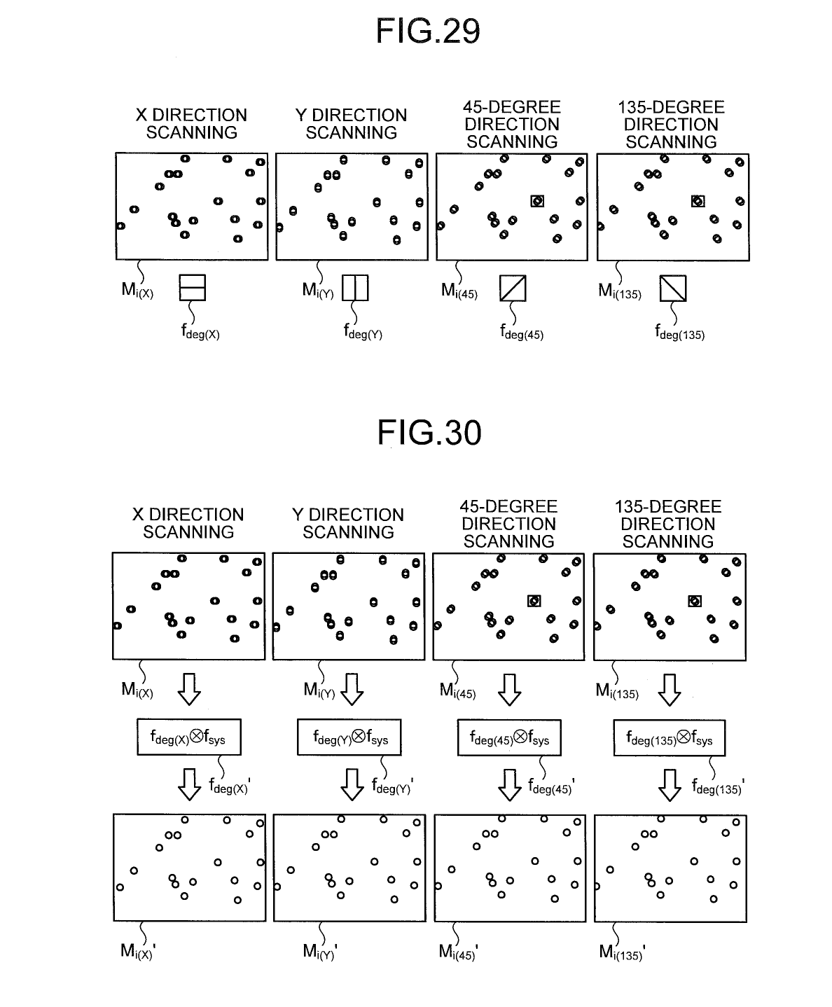

First, at step S31, the degradation function acquisition unit 311 reads related information of a plurality of images with the same observation region and different scanning directions, and acquires degradation functions based on the scanning directions, scanning speeds, and a system parameter. To be specific, as illustrated in FIG. 29, the degradation function acquisition unit 311 acquires degradation functions f_{deg(X)}, f_{deg(Y)}, f_{deg(45)}, and f_{deg(135)} serving as bases according to the scanning directions and the scanning speeds of the images M_{i(X)}, M_{i(Y)}, Mᵢ₍₄₅₎, and Mᵢ₍₁₃₅₎. Further, the degradation function acquisition unit 311 acquires a parameter (degradation function f_{sys}) unique to the system stored in a system parameter storage unit 241. Then, the degradation function acquisition unit 311 acquires degradation functions f_{deg(X)}′, f_{deg(Y)}′, f_{deg(45)}′f_{deg(135)}′ to be used in processing of restoring images M_{i(X)}, M_{i(Y)}, Mᵢ₍₄₅₎, and Mᵢ₍₁₃₅₎, by providing degradation information unique to the system, by performing a convolution operation of a parameter unique to the system, on the degradation functions serving as the bases.

At step S32, the image restoration processing unit 412 restores images degraded by scanning, using the degradation functions acquired at step S31. FIG. 30 is a diagram for describing processing of restoring images using the degradation functions. As illustrated in FIG. 30, for example, the image restoration processing unit 412 can obtain restored images M_{i(X)}′, M_{i(Y)}, Mᵢ₍₄₅₎′, and Mᵢ₍₁₃₅₎′ by restoring the images M_{i(X)}, M_{i(Y)}, Mᵢ₍₄₅₎ and Mᵢ₍₁₃₅₎ using the degradation functions f_{deg(X)}′, f_{deg(Y)}′, f_{deg(45)}′, and f_{deg(135)}′. Note that a technique of image restoration processing is as described in the first embodiment (see step S14 of FIG. 5).

At step S33, the composite restored image creation unit 413 composites the restored images restored at step S32. Hereinafter, processing of compositing restored images will be described with reference to FIGS. 23 and 24. In the description below, the images M_{i(X)}, M_{i(Y)}, Mᵢ₍₄₅₎, and Mᵢ₍₁₃₅₎ illustrated in FIGS. 23 and 24 can be replaced by the restored images M_{i(X)}′, M_{i(Y)}′, Mᵢ₍₄₅₎′, and Mᵢ₍₁₃₅₎′.

First, the composite restored image creation unit 413 performs positioning of the restored images M_{i(X)}′, M_{i(Y)}′, Mᵢ₍₄₅₎′, and Mᵢ₍₁₃₅₎′. The positioning can be executed using a known technology such as a phase-only correlation method.

Following that, the composite restored image creation unit 413 trims a common range Rₜᵣₘ of the restored images M_{i(X)}, M_{i(Y)}, Mᵢ₍₄₅₎, and Mᵢ₍₁₃₅₎ to determine composite ranges to composite the images M_{i(X)}′, M_{i(Y)}′, Mᵢ₍₄₅₎′, and Mᵢ₍₁₃₅₎′.

Following that, the direction determination processing unit 413a calculates the image selection evaluation values for images (region images) of partial regions or pixels in the restored images M_{i(X)}′, M_{i(Y)}′, Mᵢ₍₄₅₎′, and Mᵢ₍₁₃₅₎′, based on scanning directions of the respective restored images M_{i(X)}′, M_{i(Y)}′, Mᵢ₍₄₅₎′, and Mᵢ₍₁₃₅₎′. Note that a method of calculating the image selection evaluation values is similar to that in the second embodiment (see step S203 of FIG. 22 and FIG. 24).

Following that, the image selection processing unit 413b selects optimum region images to be used for image composite, from the restored images M_{i(X)}′, M_{i(Y)}′, Mᵢ₍₄₅₎′, and Mᵢ₍₁₃₅₎′, based on the image selection evaluation values. Note that a method of selecting the region images is similar to that in the second embodiment (see step S204 of FIG. 22 and FIG. 24).

Following that, the image complement unit 413c creates a composite restored image by compositing the region images selected by the image selection processing unit 413b. Note that a method of compositing the region images is similar to that in the second embodiment (see step S207 of FIG. 22).

At step S34, the control unit 41 associates the composite restored image obtained by compositing of the restored images M_{i(X)}′, M_{i(Y)}′, Mᵢ₍₄₅₎′, and Mᵢ₍₁₃₅₎′ with image position information of observation regions Pᵢ, and stores the composite restored image and the image position information in an image storage unit 242 and an image position information storage unit 243.

After the processing of the loop C has been completed, at step S35, the stitching processing unit 235 reads out the composite restored images stored in the image storage unit 242, and stitches mutually adjacent composite restored images, by reference to the image position information associated with the respective composite restored images. Note that details of processing of stitching the composite restored images are similar to those in the first embodiment (see FIGS. 14 and 19).

Further, at step S36, the control unit 41 stores a specimen image (virtual slide image) created as described above in a storage unit 24. Alternatively, the control unit 41 may display the specimen image on a display device 27.

As described above, according to the third embodiment, the images are restored using the degradation functions according to the scanning directions, and thus the positioning can be easily performed in the subsequent image composite processing. Further, in the restored images, edges according to the scanning directions become strong, and thus selecting accuracy of optimum region images based on the image selection evaluation values can be improved. Therefore, by stitching of the composite restored images that are composite restored images of the observation regions, a virtual slide image with higher quality can be obtained.

### Modification 3-1

In the third embodiment, the composite image of the restored images M_{i(X)}′, M_{i(Y)}′, Mᵢ₍₄₅₎′, and Mᵢ₍₁₃₅₎′ has been created by a technique similar to the second embodiment. However, the composite image may be created using an arithmetic mean of corresponding pixels in the restored images M_{i(X)}′, M_{i(Y)}′, Mᵢ₍₄₅₎′, and Mᵢ₍₁₃₅₎′, similarly to the first embodiment.

The above-described first to third embodiments and modifications are not limited per se, and various inventions can be formed by appropriately combining of a plurality of configuration elements disclosed in the embodiments and the modifications. For example, the invention may be formed, excluding some of configuration elements from all of the configuration elements described in the embodiments. Further, the invention may be formed, appropriately combining configuration elements described in different embodiments.

According to some embodiments, image composite processing and image restoration processing based on degradation information are performed on at least two images acquired by executing of imaging while moving an observation region with respect to an object in at least two different directions. It is therefore possible to obtain an image in which information lacked according to a moving direction has been highly accurately corrected. Accordingly, when imaging is performed sequentially while the field of view with respect to the object is shifted, an image with higher quality than before can be acquired in a short time.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An imaging device comprising:
an imaging unit configured to image an object to acquire an image of the object;
an imaging controller configured to cause the imaging unit to execute imaging while moving an observation region of the imaging unit with respect to the object in at least two different directions;
a degradation information acquisition unit configured to acquire degradation information that indicates degradation caused in the image acquired by the imaging unit due to the moving of the observation region; and
an image processing unit configured to perform, on at least two images, image composite processing and image restoration processing based on the degradation information, the at least two images having been acquired, by the imaging unit, by moving a same observation region in different directions.

2. The imaging device according to claim 1, wherein
the image processing unit is configured to create a composite image by compositing the at least two images acquired by the imaging unit, and to perform the image restoration processing on the composite image.

3. The imaging device according to claim 1, wherein
the image processing unit is configured to perform the image restoration processing on the at least two images acquired by the imaging unit.

4. The imaging device according to claim 3, wherein
the image processing unit is configured to perform the image restoration processing on a selected region image of at least two region images which are respectively included in the at least two images and which are images of corresponding regions between the at least two images.

5. The imaging device according to claim 4, wherein
the image processing unit is configured to select one region image for the image restoration processing, using a specified evaluation value, and to use, as a restored image of the region, an image obtained by performing the image restoration processing on the one region image.

6. The imaging device according to claim 4, wherein
the image processing unit is configured to select one or more region images for the image restoration processing, using a specified evaluation value,
when selecting one region image, the image processing unit is configured to use, as the restored image of the region, an image obtained by performing the image restoration processing on the one region image, and
when selecting two or more region images, the image processing unit is configured to use, as the restored image of the region, an image obtained by performing the image restoration processing on each of the two or more region images and then compositing the two or more region images.

7. The imaging device according to claim 3, wherein
the image processing unit is configured to create at least two restored images by performing the image restoration processing on each of the at least two images, and to composite the two restored images.

8. A microscope system comprising:
the imaging device according to claim 1;
a stage on which the object is configured to be placed; and
a movement unit configured to move one of the stage and the imaging unit relative to the other.

9. An imaging method comprising:
an imaging step of imaging an object to acquire an image of the object while moving an observation region with respect to the object in at least two different directions;
a degradation information acquisition step of acquiring degradation information that indicates degradation caused in the image acquired at the imaging step due to the moving of the observation region; and
an image processing step of performing, on at least two images, image composite processing and image restoration processing based on the degradation information, the at least two images having been acquired at the imaging step by moving a same observation region in different directions.
